(19) United States
(12) Patent Application Publication
(10) Pub. No.: US 2024/0360345 A1
(43) Pub. Date: Oct. 31, 2024

(54) CHEMICAL-RESISTANT REACTIVE PRESSURE-SENSITIVE ADHESIVE TAPE

(71) Applicant: tesa SE, Norderstedt (DE)

(72) Inventors: Marco Kupsky, Quickborn (DE); Francisco Lossada, Norderstedt (DE); Bastian Kruskop, Norderstedt (DE); Christian Schuh, Hamburg (DE); Lena-Marie Naujoks, Prisdorf (DE); Nadine Wedel, Hamburg (DE)

(73) Assignee: tesa SE, Norderstedt (DE)

(21) Appl. No.: 18/646,359

(22) Filed: Apr. 25, 2024

(30) Foreign Application Priority Data
Apr. 28, 2023 (DE) 102023111055.1

(51) Int. Cl. C09J 7/38; C09J 133/06

(52) U.S. Cl. CPC C09J 7/385; C09J 133/068; C09J 2203/326; C09J 2301/302; C09J 2301/416; C09J 2301/50; C09J 2433/00; C09J 2463/00

(57) ABSTRACT

A chemical-resistant, reactive, pressure-sensitive adhesive tape with a reactive adhesive compound comprising at least one epoxide compound, at least one initiator for curing the epoxide compound, and a poly(meth)acrylate which contains a high fraction of at least 55 percent by weight of monomers having aromatic radicals.

### CROSS-REFERENCE TO RELATED APPLICATIONS

This application claims the benefit of priority under 35 U.S.C. § 119 of German Patent Application No. DE102023111055.1, entitled “CHEMICAL-RESISTANT REACTIVE PRESSURE-SENSITIVE ADHESIVE TAPE”, and filed Apr. 28, 2023, the contents of which is relied upon and incorporated herein by reference in its entirety.

### FIELD OF THE DISCLOSURE

The disclosure relates to a chemical-resistant, reactive, pressure-sensitive adhesive tape and to the use of such reactive pressure-sensitive adhesive tapes for the bonding of two or more components.

### BACKGROUND

The joining of separate elements is one of the central processes in manufacturing. Besides other methods, such as welding and soldering, for example, an important significance is nowadays accorded in particular to adhesive bonding, i.e., to joining using an adhesive. One alternative to the use of formless adhesives which are applied from a tube, for example, are so-called adhesive tapes. Known from everyday life in particular are pressure-sensitive adhesive tapes, where a pressure-sensitive adhesive compound provides the bonding effect, which under typical ambient conditions is durably tacky and also adhesive. Such pressure-sensitive adhesive tapes may be applied by pressure to a substrate and remain adhering there, but later on can be removed again more or less without residue.

Particularly for use in industrial manufacturing, however, there is also another type of adhesive tapes of great significance. In these adhesive tapes, which are in some cases also referred to as reactive (pressure-sensitive) adhesive tapes, a curable adhesive compound is employed, sometimes also referred to as reactive adhesive compound. In the state intended for application, such curable adhesive compounds or reactive adhesive compound have not yet attained their maximum crosslinking, and can be cured by external influences, with initiation of the polymerization in the reactive adhesive compound and a consequent increase in the crosslinking. This is accompanied by changes in the mechanical properties of the now cured adhesive compound, with increases in particular in the viscosity, the surface hardness and the strength.

Reactive adhesive compounds are known in the prior art and from a chemical standpoint may have very different compositions. Common to these reactive adhesive compounds is the possibility of initiating the crosslinking reaction by means of external influencing factors, such as by supply of energy, for example, in particular through thermal curing, plasma curing or radiation curing, and/or by contact with a substance that promotes the polymerization, as is the case, for example, with moisture-curing adhesive compounds. Illustrative adhesive compounds are disclosed for example in DE 102015222028 A1, EP 3091059 A1, EP 3126402 B1, EP 2768919 B1, DE 102018203894 A1, WO 2017174303 A1 and U.S. Pat. No. 4,661,542 Å.

One type of reactive adhesive compounds of particular industrial relevance are those comprising cationically curable epoxide components. The handling and application properties and also the realizable adhesive properties of such reactive adhesive compounds are seen as making such adhesive tapes particularly advantageous for a wide spectrum of industrial applications. Pressure-sensitive adhesive tapes with reactive adhesive compounds comprising cationically curable epoxide components are particularly advantageous since they are substantially easier to apply, with greater positional accuracy, than liquid adhesives. Moreover, such reactive adhesive compounds are able after curing to function as structural adhesive or semi-structural adhesives. According to DIN EN 923: 2006-01, structural adhesives are adhesives that form bonds which, in a structure, have the capacity to retain a specified strength for a given, relatively long time span (according to the ASTM definition: “bonding agents used for transferring required loads between adherends exposed to service environments typical for the structure involved”). They are, accordingly, adhesives for bonds which can be highly stressed chemically and physically and which in the cured state contribute to the strengthening of the adhesive tapes.

Reactive pressure-sensitive adhesive tapes are well-known to the skilled person. For instance, WO 2023/274875 Å1 discloses reactive adhesive tapes comprising a film, a first outer reactive adhesive compound and a second outer reactive adhesive compound, with at least one of the reactive adhesive compounds comprising a reactive component such as an epoxy resin, a photoinitiator, one or more foaming agents and more than 60.0% by weight of a polymer, and where reactive adhesive compound is foamed. With these adhesive tapes, the capacity for die cutting is improved through the use of a film in combination with a foamed adhesive compound.

U.S. Pat. No. 10,676,655 B2 discloses a curable pressure-sensitive adhesive (PSA) which on curing provides a semistructural or structural adhesive that has improved cold flow properties and exceptional adhesion properties and that comprises a) a tetrahydrofurfuryl (meth)acrylate copolymer, b) an epoxy resin, c) a polyether polyol, d) a hydroxy-functional film-forming polymer, and (e) a cationic photoinitiator.

WO 2017/174303 Å1 describes a pressure-sensitive adhesive tape containing a radiation-activatable polymerizable composition which itself contains
A 5 to 60 parts by weight of at least one film-former component;
B 40 to 95 parts by weight of at least one epoxide component;
C 0.1 to 10 parts by weight of at least one photoinitiator; and
D optionally 0.1 to 200 parts by weight of at least one adjuvant,
   based in each case on the radiation-activatable polymerizable composition, where the parts by weight of components A and B add up to 100, and which is characterized in that the film-former component A comprises at least a polyurethane polymer. This radiation-activatable polymerizable composition is said to have a sufficient open time of at least one minute and to exhibit a satisfactory dark reaction after radiative activation and also a good ultimate bond strength of at least 2 MPa on steel.

EP 3091059 Å1 discloses a pressure-sensitive adhesive tape, containing a (semi-)structural adhesive compound containing at least one polymer, optionally a tackifier resin, at least one reactive resin, the adhesive compound containing at least 104 parts of the at least one reactive resin to 100 parts of polymer and tackifier resin, and at least one initiator and/or curing agent and/or accelerator; after curing, the adhesive tape displays markedly higher shear strengths than other adhesive tapes/adhesive compound of the prior art.

These kinds of reactive adhesive compounds, and pressure-sensitive adhesive tapes containing reactive adhesive compound, are suitable especially for miniaturized applications, such as the kind required in the electronics industry, for example. Here it is becoming increasingly important to make the bonds between the components very precise and space-saving. Moreover, on account of the still significant demand worldwide for electronics for communication and entertainment, the performance requirements for the devices are also continually on the increase, meaning that the adhesive tapes used are subject as well to continually new, but at least growing, requirements with regard to their performance. In particular, owing for example to the development of body-worn electronic devices (“wearables”) such as smart watches, it is becoming ever more important for the adhesive bonds used therein to exhibit not only the high bond strengths (as expected of (semi-)structural adhesives) but also a high level of resistance toward various chemicals (such as, for example, perspiration, skin oil or sebum, sun protection creams or cosmetic skincare products). This resistance toward chemicals (or “chemical resistance”) is simulated such that even after prolonged storage in various media, the cured pressure-sensitive adhesive tapes have acceptable bond strength, with ideally little or no loss of bond strength at all. Similar requirements are also being increasingly imposed for other electronic devices such as smartphones, tablets, notebook PCs, cameras, videocameras, keyboards and touchpads.

Whereas the bond strength of the adhesive compounds known from the above-stated disclosures is sufficiently high in the cured state, the resistance toward chemicals (chemical resistance) is nevertheless minimal. In the light of the observations above, there is a great requirement for pressure-sensitive adhesive tapes which exhibit improved chemical resistance. It should of course likewise be borne in mind that the (ultimate) bond strength, the capacity for die cutting, and the initial tack ought to remain at least at the same level.

### SUMMARY OF THE DISCLOSURE

The primary object of the present disclosure was to eliminate or at least alleviate the disadvantages described above for the prior art.

The object of the present disclosure more particularly was to provide a reactive, pressure-sensitive adhesive tape that exhibits improved chemical resistance, toward perspiration, skin oil or sebum, sun protection cream or cosmetic skincare product, for example, and toward a mixture of isopropanol/water. In the development of adhesive tapes, a 7:3 isopropanol/water mixture is often chosen for optimizing adhesive compounds in respect of their chemical resistance toward polar solvents. This mixture, accordingly, is a so-called gatekeeper, which is to be in place before the full spectrum of different chemicals is tested.

A further object of the present disclosure was to provide a reactive, pressure-sensitive adhesive tape which exhibits not only sufficient or improved chemical resistance but also high or improved bond strength.

A further object of the present disclosure was to provide a reactive, pressure-sensitive adhesive tape which exhibits good or improved (initial) tack and at the same time possesses sufficient or improved chemical resistance.

A further object of the present disclosure was to provide a reactive, pressure-sensitive adhesive tape which in the cured state exhibits a high or improved bond strength.

A secondary object of the present disclosure, moreover, was to provide for use of the reactive, pressure-sensitive adhesive tapes under specification for the bonding of two or more components.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding, and are incorporated in and constitute a part of this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### DETAILED DESCRIPTION

In the following detailed description, for purposes of explanation and not limitation, example embodiments disclosing specific details are set forth to provide a thorough understanding of various principles of the release liner of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an,” and “the” include plural referents unless the context clearly dictates otherwise. Thus, for example, reference to a “component” includes aspects having two or more such components, unless the context clearly indicates otherwise.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

All of the statements in the description apply to the chemical-resistant reactive pressure-sensitive adhesive tape of the disclosure.

The disclosure, moreover, embraces all the features which are subjects of any dependent claims. Further, the disclosure embraces combinations of individual features with one another, including at different preference levels. The disclosure thus embraces, for example, the combination of a first feature identified as being “preferred” with a second feature identified as being “particularly preferred”. In this context, subjects identified as part of “embodiments”, likewise at different preference levels, are also embraced.

In connection with the present disclosure, it has been found that the objects described above can surprisingly be achieved if the basis used in the reactive adhesive compound for the reactive pressure-sensitive adhesive tape of the disclosure comprises a poly(meth)acrylate with a high fraction of at least 55 percent by weight of monomers having aromatic radicals, such as phenyl, phenylene, naphthyl or naphthylene, with phenyl or phenylene being particularly preferred, in combination with at least one epoxide compound and at least one initiator for curing the reactive adhesive compound, as defined in the claims.

Surprisingly and contrary to expectations, it has been determined that these fractions and also very high fractions (75% or 100% by weight) of aromatic radicals in the poly(meth)acrylate lead to improved chemical resistance of the overall system of the reactive adhesive compounds, so that the reactive pressure-sensitive adhesive tapes of the disclosure exhibit improved chemical resistance. Additionally, it has been surprisingly determined that the initial tack of the reactive pressure-sensitive adhesive tape of the disclosure with the reactive adhesive compound based on the poly(meth)acrylate with a fraction of at least 55 percent by weight of monomers having aromatic radicals is sufficiently high and that application (and repositioning) in the course of use for the bonding of two components is very successful. Lastly, it has been surprisingly determined that the bond strengths of the reactive pressure-sensitive adhesive tapes of the disclosure (after curing) are sufficiently high to function after curing as a (semi-)structural adhesive. This is particularly surprising since awareness was only of low bond strengths for (semi-)structural adhesives which contain 2-phenoxyethyl acrylate as a monomer.

The term “(semi-)structural adhesive” or “(semi-)structural adhesives” embraces the “semi-structural adhesives” and the “structural adhesives”. “Semi-structural adhesives” are those cured adhesives which in the lap shear test have a lap shear strength of at least 1.0 MPa and more preferably at least about 1.5 MPa (in each case on steel). “Structural adhesives” refer to those cured adhesives which have a particularly high lap shear strength and which in the lap shear test have a lap shear strength of at least 5 MPa, more preferably of at least 7 MPa and particularly preferably of at least 10 MPa (in each case on steel).

Without being tied to any particular theory, it is believed that the combination of (a) poly(meth)acrylate having a high fraction of at least 55 percent by weight of monomers having aromatic radicals, (b) at least one epoxide compound and (c) at least one initiator has synergistic effects in the reactive adhesive compound of the reactive pressure-sensitive adhesive tapes of the disclosure in relation to the chemical resistance, initial tack, and bond strength.

The objects stated above are achieved accordingly by the subject matter of the disclosure as defined in the claims. Preferred configurations according to the disclosure are apparent from the dependent claims and from the observations below.

The disclosure relates to a reactive pressure-sensitive adhesive tape comprising at least one reactive adhesive compound containing

a basis compound, where the basis compound contains
(a) 35% to 80% by weight of at least one poly(meth)acrylate, and
(b) 20% to 65% by weight of at least one epoxide compound,
the total amount of poly(meth)acrylates and epoxide compounds in the basis compound making 100% by weight;
   and where the reactive adhesive compound further comprises
(c) 0.1% to 5% by weight, based on 100% by weight of the basis compound, of at least
one initiator, more particularly photoinitiator, for curing the epoxide compound;
   wherein
   the poly(meth)acrylate derives from a monomer composition which comprises or consists of
(i) 55% to 100% by weight of one or more monomers selected from the group consisting of
   a. one or more monomers of the formula (I)

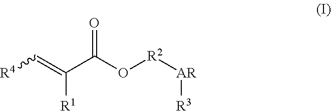

in which R¹ is a hydrogen atom or a methyl group,
R² is an unsubstituted, linear or branched C₁-C₂₂ alkyl chain,
AR is an aromatic radical,
R³ is H, an unsubstituted, linear or branched C₁-C₅ alkyl chain, a hydroxyl
group, C₁-C₁₀ alkoxy group or aryloxy group, and
R⁴ is H or a phenyl ring,
b. one or more monomers of the formula (II)

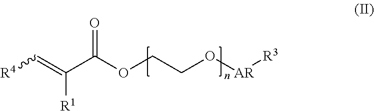

in which R¹ is a hydrogen atom or a methyl group,
AR is an aromatic radical,
R³ is H, an unsubstituted, linear or branched C₁-C₅ alkyl chain, a hydroxyl
group, C₁-C₁₀ alkoxy group or aryloxy group, and
R⁴ is H or a phenyl ring, and n is 0 to 10,
c. styrene, and
d. methylstyrene; and
(ii) 0% to 45% by weight of one or more comonomers, where the comonomer or comonomers are selected from the group of the (meth)acrylate monomers and copolymerizable vinyl monomers, and where there is no match between the comonomer or comonomers and the monomers of the formula (I), the monomers of the formula (II), styrene and methylstyrene, where the weight fractions are each based on the total weight of the monomer composition.

Embodiments referred to below as preferred are combined in particularly preferred embodiments with features of other embodiments referred to as preferred. Especially preferred, accordingly, are combinations of two or more of the embodiments referred to below as particularly preferred. Likewise preferred are embodiments in which a feature of one embodiment that is referred to in any degree as preferred is combined with one or more further features of other embodiments that are referred to in any degree as preferred. Features of preferred uses and methods are apparent from the features of preferred reactive pressure-sensitive adhesive tapes.

For optimal workability for the end user, the reactive adhesive compound of the present disclosure has pressure-sensitive adhesive properties or an intrinsic pressure-sensitive adhesiveness or tack. The reactive adhesive compound may therefore be classed as a pressure-sensitive adhesive compound (PSA). The tack allows the reactive pressure-sensitive adhesive tapes, before curing, to be applied reliably and securely on the substrate.

A pressure-sensitive adhesive compound (PSA), in agreement with the understanding of the skilled person, is an adhesive compound which possesses pressure-sensitive adhesive properties—that is, the property of entering into a durable bond to a substrate under just relatively weak applied pressure. Corresponding pressure-sensitive adhesive tapes typically are substantially detachable from the substrate again after use and in general have permanent intrinsic stickiness even at room temperature, meaning that they have a certain viscosity and touch-tack, so that they wet the surface of a substrate under just low applied pressure. The tack of a pressure-sensitive adhesive tape is a product of the use of a PSA as the adhesive compound. Without wanting to be tied to this theory, it is frequently assumed that a PSA may be viewed as a liquid of extremely high viscosity with an elastic fraction, which accordingly has characteristic viscoelastic properties which lead to the above-described durable intrinsic stickiness and pressure-sensitive adhesiveness. It is assumed that in the case of such PSAs, mechanical deformation is accompanied both by viscous flow processes and by development of elastic restoring forces. The fractional viscous flow serves here for the attainment of adhesion, while the fractional elastic restoring forces are needed in particular for the attainment of cohesion. The relationships between the rheology and the tack are known in the prior art and described for example in “Satas, Handbook of Pressure Sensitive Adhesives Technology”, third edition (1999), pages 153 to 203, which is incorporated herein by reference.

For more precise description and quantification of the extent of elastic and viscous fractions, and also of the relationship between the fractions, the variables of storage modulus (G′) and loss modulus (G″) are employed, and can be determined by means of dynamic mechanical analysis (DMA). G′ is a measure of the elastic fraction and G″ a measure of the viscous fraction, of a substance. Both variables are dependent on the deformation frequency and the temperature.

The variables can be determined using a rheometer. In that case, for example, the material under investigation is exposed in a plate/plate arrangement to a sinusoidally oscillating shear stress. In the case of instruments operating with shear stress control, the deformation is measured as a function of time, and the time offset of this deformation is measured relative to the introduction of the shear stress. This time offset is referred to as the phase angle 6. The storage modulus G′ is defined as follows: G′=(τ/γ)*cos(6) (τ=shear stress, γ=deformation, δ=phase angle=phase shift between shear stress vector and deformation vector). The definition of the loss modulus G″ is as follows: G″=(τ/γ)*sin(6) (τ=shear stress, γ=deformation, δ=phase angle=phase shift between shear stress vector and deformation vector).

In the context of the present disclosure, an adhesive compound is understood preferably to be pressure-sensitively adhesive, and hence to be a pressure-sensitive adhesive compound (PSA), when at a temperature of 23° C., in the deformation frequency range from 10⁰ to 10¹ rad/sec, both G′ and G″ are situated at least partly in the range from 10³ to 10⁷ Pa. “Partly” means that at least a portion of the G′ curve lies within the window which is subtended by the deformation frequency range from 10⁰ inclusive to 10¹ inclusive rad/sec (abscissa) and by the range of the G′ values from 10³ inclusive to 10 inclusive Pa (ordinate), and when at least a portion of the G″ curve is likewise situated within the corresponding window. For simplification, the disclosure defines a reactive pressure-sensitive adhesive tape in the sense of the present disclosure as possessing a peel adhesion in the uncured state of at least 1 N/cm and being removed virtually without residue (i.e., an adhesive failure in the test). The peel adhesion is determined here on steel in analogy to ISO 29862:2007 (Method 3) at 23° C. and 50% relative humidity at a peeling speed of 300 mm/min and a peel angle of 180°. The reinforcing film used is an etched polyethylene terephthalate (PET) film with a thickness of 36 μm, as available from Coveme (Italy). A measurement strip 2 cm wide is bonded using a roller machine with 4 kg at a temperature of 23° C. The adhesive tape is peeled off immediately after application. The measurement value (in N/cm) is the average value from three individual measurements. Cohesive failure in this test is displayed by adhesives or adhesive tapes which are tacky at room temperature but whose cohesion is not sufficient for residue-free removal. For the purposes of the disclosure, such adhesives or adhesive tapes are not PSAs.

The reactive pressure-sensitive adhesive tapes of the disclosure feature good or very good resistance toward chemicals (“chemical resistance”) and in this respect are regularly superior to known reactive pressure-sensitive adhesive tapes from the prior art, which frequently exhibit no chemical resistance at all. A particular feature of the chemical resistance is that even the correspondingly stored pressure-sensitive adhesive tapes result in bonds whose properties after bonding, particularly their bond strengths, are very good. Pressure-sensitive adhesive tapes possessing relatively poor chemical resistance, on the other hand, lead to bonding products of lower stability when the bonding product is exposed to such conditions.

The reactive pressure-sensitive adhesive tapes of the disclosure exhibit good chemical resistance, with corresponding values in the push-out test (described later on below) of at least 0.1 MPa after storage for 72 h at 65° C. in isopropanol/water (70% volume fractions/30% volume fractions). They preferably exhibit very good chemical resistance, with corresponding values in the push-out test (described later on below) of at least 0.5 MPa and particularly preferably they exhibit outstanding chemical resistance, with corresponding values in the push-out test (described later on below) of at least 1 MPa, both after storage for 72 h at 65° C. in isopropanol/water (70/30).

The term “poly(meth)acrylate” in accordance with the disclosure embraces polymers based on esters of acrylic acid and polymers based on esters of acrylic acid and methacrylic acid and also polymers based on esters of methacrylic acid. The terms “(meth)acrylic ester” and “(meth)acrylate” in accordance with the disclosure embrace acrylic esters and methacrylic esters and, respectively, acrylates and methacrylates.

The reactive adhesive compound of the reactive pressure-sensitive adhesive tape of the disclosure comprises a basis compound defined by the total amount of poly(meth)acrylates and epoxide compounds.

The total weight of the constituents of the basis compound of the reactive adhesive compound here and below therefore represents the total amount of polymethacrylates and epoxide compounds used, which is obtained as a total in percent by weight (% by weight) and corresponds to 100% by weight, the percentages always adding up to 100 percent by weight.

This means that in embodiments disclosed below in which preferred configurations are disclosed for the poly(meth)acrylates under (i), it is also necessary to make unaltered use of other, non-preferred poly(meth)acrylates in the adhesive compound of the disclosure for the calculation of the weight fractions, since these polymers as well form a part of the basis compound.

The basis compound here preferably consists of the more closely defined poly(meth)acrylates and epoxide compounds, meaning in particular that poly(meth)acrylates not deriving from the monomer composition from (i) and (ii) of any embodiments and configurations are preferably not constituents of the basis compound.

Any further constituents optionally present, such as solvents and/or water, serve only for production and in this consideration are not counted as part of the total weight of the constituents of the basis compound of the adhesive compound of the disclosure or of the adhesive film of the disclosure. The same is true of solvents which may already be included in the commercially available raw materials. Further, the amount of any additives present, as described below, is not counted as part of the 100 percent by weight of the basis compound.

The reactive adhesive compound contains preferably 50% or more, preferably 70% or more, particularly preferably 80% or more, especially preferably 90% or more, particularly preferably 95% or more, of the basis compound, based on the total mass of the reactive adhesive compound.

The basis compound of the reactive adhesive compound of the reactive pressure-sensitive adhesive tape of the disclosure comprises 35% to 80% by weight of at least one poly(meth)acrylate
(a); in particular, the basis compound of the reactive adhesive compound comprises 40% to 70% by weight and more preferably 45% to 65% by weight of at least one poly(meth)acrylate (a), based in each case on the total weight of the basis compound of the reactive adhesive compound.

The weight percentage figures (% by weight) are based on the at least one poly(meth)acrylate or on the sum total of all poly(meth)acrylates, if two or more poly(meth)acrylates are present.

As the balance to 100% by weight of the basis compound, the adhesive compound additionally contains (c) 0.1% to 5% by weight, based on 100% by weight of the basis compound, of at least one initiator for curing the epoxide compound.

The one or more poly(meth)acrylates of the basis compound of the reactive adhesive compound in the reactive pressure-sensitive adhesive tape of the disclosure derive from a monomer composition which comprises or consists of
(i) 55% to 100% by weight of one or more monomers selected from the group consisting of
   a. one or more monomers of the formula (I)

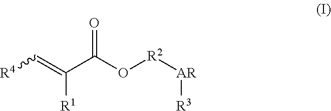

in which R¹ is a hydrogen atom or a methyl group,
R² is an unsubstituted, linear or branched C₁-C₂₂ alkyl chain,
AR is an aromatic radical,
R³ is H, an unsubstituted, linear or branched C₁-C₅ alkyl chain, a hydroxyl
group, C₁-C₁₀ alkoxy group or aryloxy group, and
R⁴ is H or a phenyl ring,
b. one or more monomers of the formula (II)

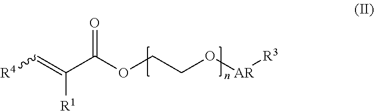

in which R¹ is a hydrogen atom or a methyl group,
AR is an aromatic radical,
R³ is H, an unsubstituted, linear or branched C₁-C₅ alkyl chain, a hydroxyl
group, C₁-C₁₀ alkoxy group or aryloxy group, and
R⁴ is H or a phenyl ring, and n is 0 to 10,
c. styrene, and
d. methylstyrene; and
(ii) 0% to 45% by weight of one or more comonomers, where the comonomer or comonomers are selected from the group of the (meth)acrylate monomers and copolymerizable vinyl monomers, and where there is no match between the comonomer or comonomers and the monomers of the formula (I), the monomers of the formula (II), styrene and methylstyrene, where the weight fractions are each based on the total weight of the monomer composition.

The poly(meth)acrylates may be prepared in principle using all radical or radically controlled polymerizations, and combinations of different polymerization processes as well. In addition to the conventional, free radical polymerization, this also includes, for example, atom transfer radical polymerization (ATRP), nitroxide/TEMPO-controlled polymerization or the reversible addition-fragmentation chain transfer (RAFT) process. The poly(meth)acrylates may be prepared by copolymerization of the (co)monomers using customary polymerization initiators and also, optionally, chain transfer agents, with polymerization taking place at the usual temperatures in bulk, in emulsion, as for example in water or liquid hydrocarbons, or in solution. The polymerization may be carried out in polymerization reactors, which are generally provided with a stirrer, multiple feed vessels, reflux condenser, heating and cooling and are equipped for operation under an N₂ atmosphere and superatmospheric pressure. The radical polymerization is conducted in the presence of one or more organic solvents and/or in the presence of water, or in bulk. The aim is to minimize the amount of solvent used. Depending on conversion and temperature, the polymerization time is generally between 6 and 48 hours.

The weight-average molecular weight Mw of the polymers, determined via gel permeation chromatography (GPC), is in one preferred embodiment at least 20,000 g/mol, preferably between 50,000 and 2,000,000 g/mol, more particularly between 100,000 and 2,000,000 g/mol, particularly preferably between 700,000 and 1,700,000 g/mol and especially preferably between 1,000,000 and 1,700,000 g/mol.

It is also conceivable to use mixtures of a high molecular mass (i.e., weight-average molecular weight Mw of >20,000 g/mol) poly(meth)acrylate, constructed exclusively from one or more comonomers (ii), and a low molecular mass (i.e., weight-average molecular weight Mw between 3,000 and 20,000 g/mol) poly(meth)acrylate, constructed exclusively from one or more monomers (i), in which case the ratio of high molecular mass poly(meth)acrylate to low molecular mass poly(meth)acrylate ought not to be less than 0.5, preferably not less than 1, more particularly not less than 1.25, in order to attain good pressure-sensitive adhesive properties in the uncured state.

The determination by gel permeation chromatography (GPC) is made on 100 μl of sample having undergone clarifying filtration (sample concentration 4 g/l). The eluent used is tetrahydrofuran with 0.1% by volume of trifluoroacetic acid. The measurement is made at 25° C. The precolumn used is a Polymer Standards Service (PSS) SDV-type column, 5 μm, 10³ Å, 8.0 mm×50 mm (statements here and below in the following order: type, particle size, porosity, internal diameter×length; 1 Å=10-1 m). Separation takes place using a combination of the columns of type PSS-SDV, 5 μm, 10³ Å and also 10⁵ Å and 10⁶ Åeach of 8.0 mm×300 mm (columns from Polymer Standards Service; detection by means of Shodex RI-71 differential refractometer). The flow rate is 1.0 ml per minute. Calibration takes place in the case of polyacrylates against PMMA standards (polymethyl methacrylate calibration). Calibration is carried out using the commercially available ReadyCal-Kit poly(styrene) high from PSS Polymer Standards Service GmbH, Mainz. This is converted using the Mark-Houwink parameters K and alpha universally into polymethyl methacrylate (PMMA), and so the data are reported in PMMA mass equivalents. For other molecules (resins, elastomers), calibration takes place against PS standards (polystyrene calibration).

For solution polymerization, solvents used are preferably esters of saturated carboxylic acids (e.g., ethyl acetate), aliphatic hydrocarbons (e.g., n-hexane or n-heptane), ketones (e.g., acetone or methyl ethyl ketone), special boiling point spirit, or mixtures of these solvents. Preference is given to using a solvent mixture of acetone and isopropanol, the isopropanol content being between 1 and 10 percent by weight. Polymerization initiators used are commonly typical radical-forming compounds, such as peroxides and azo compounds, for example. Initiator mixtures as well may be used. In the polymerization, it is also possible to use thiols as chain transfer agents for lowering molecular weight and reducing the polydispersity. Other possible chain transfer agents for use in polymerization include, for example, alcohols and ethers.

In one embodiment, the poly(meth)acrylates are obtained via what is called the “syrup process”. For this, in an upstream step, the monomer composition undergoes preliminary polymerization to form a syrup. This syrup is then used in the formulation of the reactive adhesive compound and is caused to react fully after the coating step, with, for example, light at a wavelength that does not activate the cationic initiator. This process can be used to obtain the adhesive tapes of the disclosure.

The aromatic radical of the groups AR is preferably selected from the group consisting of phenyl groups, phenylene groups, naphthyl groups and naphthylene groups, which may optionally carry substituents. With particular preference, the aromatic radical AR is selected from the group consisting of phenyl groups, phenylene groups, naphthyl groups and naphthylene groups, with phenyl groups or phenylene groups being especially preferred.

A “phenylene group” is understood in correspondence with the understanding of the skilled person to be a phenyl group which is at least divalent.

The same applies, analogously, to naphthylene.

In one preferred embodiment, the monomers (i) contain a phenyl ring, meaning that AR in formula (I) is a phenyl group or a phenylene group and R⁴ is hydrogen, and they are therefore selected from the group consisting of
a. one or more monomers of the formula (Ia)

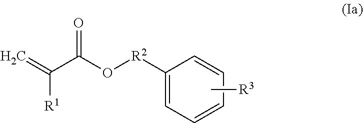

in which R¹ is a hydrogen atom or a methyl group,
R² is an unsubstituted, linear or branched C₁-C₂₂ alkyl chain, and
R³ is H, an unsubstituted, linear or branched C₁-C₅ alkyl chain, a hydroxyl group,
C₁-C₁₀ alkoxy group or aryloxy group, and
b. one or more monomers of the formula (IIa)

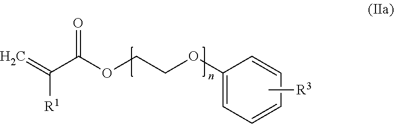

in which R¹ is a hydrogen atom or a methyl group, and
R³ is H, an unsubstituted, linear or branched C₁-C₅ alkyl chain, a hydroxyl group,
C₁-C₁₀ alkoxy group or aryloxy group, and n is 0 to 10.

The monomers (i) are preferably selected from the group of the (meth)acrylic esters of the formula (Ia) and of the (meth)acrylic esters of the formula (IIa), where, particularly for the monomers of the formula (I), n=1 to 4 is preferred and where, particularly for the monomers of the formula (IIa), unsubstituted C₁-C₈ alkyl chain is preferred for R², and H or tert-butyl is preferred for R³. More particularly, the monomers (i) are selected from the following group: benzyl acrylate, phenyl acrylate, 2-phenylethyl acrylate, 3-phenylpropyl acrylate, 4-phenylbutyl acrylate, 5-phenylpentyl acrylate, 6-phenylhexyl acrylate, benzyl methacrylate, phenyl methacrylate, 2-phenylethyl methacrylate, 3-phenylpropyl methacrylate, 4-phenylbutyl methacrylate, 5-phenylpentyl methacrylate, 6-phenylhexyl methacrylate, 2-phenoxyethyl acrylate, 2-phenoxydiethylene glycol acrylate, 2-phenoxytriethylene glycol acrylate, 2-phenoxytetraethylene glycol acrylate, 2-phenoxypentaethylene glycol acrylate, 2-phenoxyhexaethylene glycol acrylate, 2-phenoxyheptaethylene glycol acrylate, 2-phenoxyoctaethylene glycol acrylate, 2-phenoxynonaethylene glycol acrylate, 2-phenoxydecaethylene glycol acrylate, 2-phenoxyethyl methacrylate, 2-phenoxydiethylene glycol methacrylate, 2-phenoxytriethylene glycol methacrylate, 2-phenoxytetraethylene glycol methacrylate, 2-phenoxypentaethylene glycol methacrylate, 2-phenoxyhexaethylene glycol methacrylate, 2-phenoxyheptaethylene glycol methacrylate, 2-phenoxyoctaethylene glycol methacrylate, 2-phenoxynonaethylene glycol methacrylate, 2-phenoxydecaethylene glycol methacrylate, 4-tert-butylphenyl acrylate, 4-tert-butylphenyl methacrylate, 2-(4-tert-butyl)phenoxyethyl acrylate, 2-(4-tert-butyl)phenoxydiethylene glycol acrylate, 2-(4-tert-butyl)phenoxytriethylene glycol acrylate, 2-(4-tert-butyl)phenoxytetraethylene glycol acrylate, 2-(4-tert-butyl)phenoxypentaethylene glycol acrylate, 2-(4-tert-butyl)phenoxyhexaethylene glycol acrylate, 2-(4-tert-butyl)phenoxyheptaethylene glycol acrylate, 2-(4-tert-butyl)phenoxyoctaethylene glycol acrylate, 2-(4-tert-butyl)phenoxynonaethylene glycol acrylate, 2-(4-tert-butyl)phenoxydecaethylene glycol acrylate, 2-(4-tert-butyl)phenoxyethyl methacrylate, 2-(4-tert-butyl)phenoxydiethylene glycol methacrylate, 2-(4-tert-butyl)phenoxytriethylene glycol methacrylate, 2-(4-tert-butyl)phenoxytetraethylene glycol methacrylate, 2-(4-tert-butyl)phenoxypentaethylene glycol methacrylate, 2-(4-tert-butyl)phenoxyhexaethylene glycol methacrylate, 2-(4-tert-butyl)phenoxyheptaethylene glycol methacrylate, 2-(4-tert-butyl)phenoxyoctaethylene glycol methacrylate, 2-(4-tert-butyl)phenoxynonaethylene glycol methacrylate, 2-(4-tert-butyl)phenoxydecaethylene glycol methacrylate.

With particular preference, the monomers (i) are selected from the group consisting of benzyl acrylate, phenyl acrylate, benzyl methacrylate, phenyl methacrylate, 2-phenoxyethyl acrylate, 2-phenoxyethyl methacrylate. Very preferably indeed, the monomers (i) are selected from benzyl acrylate and benzyl methacrylate.

In principle, the comonomers (ii) are selected from all (meth)acrylate monomers and other radically copolymerizable vinyl monomers that are known to the skilled person, such as acrylonitrile or N-vinylcaprolactam, for example, which are copolymerizable with the monomers
(i), where there is no match between the comonomers (ii) and the monomers (i), i.e., the monomers of the formulae (I) or (Ia), of the formulae (II) or (IIa), styrene and methylstyrene.

Examples of such comonomers (ii) are acrylic acid, carboxyethyl acrylates, caprolactone acrylate, 1,4-cyclohexanedimethanol monoacrylate, 2,3-dihydroxypropyl methacrylate, 4-hydroxybutyl acrylate, 2-hydroxyethyl acrylate, 2-hydroxyethyl methacrylate, hydroxypropyl acrylate, n-butyl acrylate, n-butyl methacrylate, behenyl acrylate, behenyl methacrylate, cetyl acrylate, ethyl acrylate, ethyl methacrylate, 2-ethylhexyl acrylate, 2-ethylhexyl methacrylate, 2-ethylhexyl diglycol acrylate, n-hexyl acrylate, isobutyl acrylate, isobutyl methacrylate, icosyl acrylate, isoheptadecyl acrylate, isoheptadecyl methacrylate, isostearyl acrylate, isodecyl acrylate, isodecyl methacrylate, isononyl acrylate, isooctyl acrylate, lauryl acrylate, lauryl methacrylate, tetradecyl acrylate, methyl acrylate, methyl methacrylate, methoxyethyl acrylate, n-octyl acrylate, 2-octyl acrylate, n-decyl acrylate, propylheptyl acrylate, stearyl acrylate, stearyl methacrylate, tert-butyl acrylate, tert-butyl methacrylate, cyclohexyl acrylate, cyclohexyl methacrylate, (5-ethyl-1,3-dioxan-5-yl)methyl acrylate, dihydrodicyclopentadienyl acrylate, isobornyl acrylate, isobornyl methacrylate, norbornyl acrylate, 4-tert-butylcyclohexyl acrylate, tetrahydrofurfuryl acrylate, 3,3,5-trimethylcyclohexyl acrylate, tert-butylcyclohexyl methacrylate, ethylene diglycol acrylate, potassium 3-sulfopropyl acrylate, 2-(O-[1′-methylpropylideneamino]carboxyamino)ethyl methacrylate, 2-[(3,5-dimethylpyrazolyl)carboxyamino]ethylmethacrylate, polypropylene glycol monomethacrylate, ureidomethacrylate, methacrylamide, 4-acryloylmorpholine, acrylonitrile, N,N-dimethylacrylamide, N-tert-butylacrylamide, N-methylolmethacrylamide, N-vinylcaprolactam, N-vinylpyrrolidone, vinylmethyloxazolidinone, maleic anhydride, and vinyl acetate.

With preference, the glass transition temperature (T_{g}) of a homopolymer of the respective comonomer (ii) is greater than 0° C., preferably greater than 10° C., more particularly greater than 20° C. and particularly preferably greater than 30° C. The group of the comonomers (ii) in particular does not comprise any monomers which contain more than one radically polymerizable group, since that leads to crosslinking. A non-crosslinked poly(meth)acrylate is therefore particularly preferred for the purposes of this disclosure.

Suitable preferred comonomers (ii) are selected from the group consisting of acrylic acid, 1,4-cyclohexanedimethanol monoacrylate, 2,3-dihydroxypropyl methacrylate, 2-hydroxyethyl methacrylate, n-butyl methacrylate, behenyl acrylate, behenyl methacrylate, cetyl acrylate, ethyl methacrylate, 2-ethylhexyl methacrylate, 2-ethylhexyl diglycol acrylate, n-hexyl acrylate, isobutyl acrylate, isobutyl methacrylate, icosyl acrylate, isononyl acrylate, tetradecyl acrylate, methyl acrylate, methyl methacrylate, stearyl acrylate, tert-butyl acrylate, tert-butyl methacrylate, cyclohexyl acrylate, cyclohexyl methacrylate, (5-ethyl-1,3-dioxan-5-yl)methyl acrylate, dihydrodicyclopentadienyl acrylate, isobornyl acrylate, isobornyl methacrylate, norbornyl acrylate, 4-tert-butylcyclohexyl acrylate, 3,3,5-trimethylcyclohexyl acrylate, tert-butylcyclohexyl methacrylate, potassium 3-sulfonpropyl acrylate, 2-(O-[1′-methylpropylideneamino]carboxyamino)ethyl methacrylate, 2-[(3,5-dimethylpyrazolyl)carboxyamino]ethyl methacrylate, ureidomethacrylate, methacrylamide, 4-acryloylmorpholine, acrylonitrile, N,N-dimethylacrylamide, N-tert-butylacrylamide, N-methylolmethacrylamide, N-vinylcaprolactam, N-vinylpyrrolidone, vinylmethyloxazolidinone, maleic anhydride, and vinyl acetate.

Particularly suitable as comonomer (ii) are (meth)acrylic esters which are selected from the group consisting of (meth)acrylic esters having cyclic carbon side groups, (meth)acrylic esters whose carbon side groups are linear or branched and have more than 10 carbon atoms, and
(meth)acrylic esters whose homopolymer glass transition temperatures are greater than 0° C.

With particular preference, the comonomers (ii) are selected from the group consisting of the following: acrylic acid, stearyl acrylate, methyl acrylate, tert-butyl acrylate, cyclohexyl acrylate, dihydrodicyclopentadienyl acrylate, isobornyl acrylate, 1,4-cyclohexanedimethanol monoacrylate, methyl methacrylate, 2-hydroxyethyl methacrylate, tert-butylcyclohexyl methacrylate, behenyl methacrylate, n-butyl methacrylate, cyclohexyl methacrylate, ethyl methacrylate, isobutyl methacrylate, tert-butyl methacrylate, isobornyl methacrylate, tert-butylcyclohexyl methacrylate, 3,4-epoxycyclohexylmethyl methacrylate, and glycidyl methacrylate. Particularly preferred are methyl methacrylate, isobornyl acrylate, methyl acrylate, and stearyl acrylate.

It has been surprisingly determined that comonomers (ii) selected from the group of (meth)acrylic esters whose carbon side groups are linear or branched and have more than 10 carbon atoms may constitute a weight fraction of up to 30%, preferably up to 25% and more particularly up to 20% by weight, based on the total weight of the monomer composition, and have no adverse effect on the chemical resistance of the reactive adhesive compound of the disclosure.

These are preferably comonomers (ii) selected from the group consisting of lauryl acrylate, lauryl methacrylate, tetradecyl acrylate, stearyl methacrylate, cetyl acrylate, tetradecyl acrylate, and stearyl acrylate, and especially preferably selected from the group consisting of cetyl acrylate, tetradecyl acrylate, and stearyl acrylate.

It has also been observed that comonomers (ii) selected from the group of (meth)acrylic esters which have cyclic carbon side groups likewise may constitute a weight fraction of up to 30%, preferably 25% and more particularly up to 20% by weight, based on the total weight of the monomer composition. Without being tied to any particular theory, it is believed that such groups do not influence the chemical resistance in either the one (polar solvents) or the other (apolar solvents) direction, owing to the mixing of the more polar ester group and the more apolar cyclic moieties.

Examples of such comonomers (ii) are selected from the group consisting of cyclohexyl acrylate, cyclohexyl methacrylate, (5-ethyl-1,3-dioxan-5-yl)methyl acrylate, dihydro-dicyclopentadienyl acrylate, isobornyl acrylate, isobornyl methacrylate, norbornyl acrylate, 4-tert-butylcyclohexyl acrylate, 3,3,5-trimethylcyclohexyl acrylate, tert-butylcyclohexyl methacrylate, 4-acryloylmorpholine, N-vinylcaprolactam, N-vinylpyrrolidone, vinyl-methyloxazolidinone, and maleic anhydride. With particular preference, the comonomers (ii) are selected from the group consisting of cyclohexyl acrylate, cyclohexyl methacrylate, (5-ethyl-1,3-dioxan-5-yl)methyl acrylate, dihydrodicyclopentadienyl acrylate, isobornyl acrylate, isobornyl methacrylate, norbornyl acrylate, 4-tert-butylcyclohexyl acrylate, 3,3,5-tri-methylcyclohexyl acrylate, and tert-butylcyclohexyl methacrylate.

The monomer composition from which the one or more poly(meth)acrylates of the reactive adhesive compound in the reactive pressure-sensitive adhesive tape of the disclosure derive consists typically of up to 15 different monomers. The monomer composition consists preferably of up to 5 different monomers, more preferably of 4 different monomers, even more preferably of 3 different monomers, more preferably still of 2 different monomers, and most preferably of one monomer and hence only of a monomer (i). In the case of a total of two monomers, preferably both monomers belong to the group of the monomers (i), and in the case of a total of three monomers, either two or all three of the monomers belong to the group of the monomers (i).

With particular preference, the monomer composition consists of a monomer (i) which is selected preferably from benzyl acrylate and benzyl methylacrylate, or the monomer composition consists of two monomers (i) which are selected from the group consisting of benzyl acrylate, phenyl acrylate, benzyl methacrylate, phenyl methacrylate, 2-phenoxyethyl acrylate, 2-phenoxyethyl methacrylate, and preferably are selected from the group consisting of 2-phenoxyethyl acrylate, 2-phenoxyethyl methacrylate, benzyl acrylate and benzyl methacrylate. Preferred combinations in this context are 2-phenoxyethyl acrylate and 2-phenoxyethyl methacrylate or benzyl acrylate and benzyl methacrylate or 2-phenoxyethyl acrylate and benzyl methacrylate.

The one or more poly(meth)acrylates of the reactive adhesive compound in the reactive pressure-sensitive adhesive tape of the disclosure derive from a monomer composition which comprises or consists of 55% to 100% by weight of one or more monomers (i) and 0% to 45% by weight of one or more comonomers (ii). More particularly, the monomer composition contains 60% to 100%, 65% to 100%, 70% to 100%, 75% to 100%, 80% to 100% or 90% to 100% by weight of one or more monomers (i). Corresponding amounts of one or more comonomers (ii) are included, and so preferably a total of 100% by weight is reached. Preferably there are 70% to 100%, more preferably 80% to 100%, more preferably still 90% to 100% and especially preferably 100% by weight of one or more monomers (i).

In one preferred embodiment, the one or more poly(meth)acrylates of the reactive adhesive compound in the reactive pressure-sensitive adhesive tape of the disclosure are substantially inert to the at least one epoxide compound and to the at least one initiator and also to any remaining substances. Inert in this context means that the at least one epoxide compound and any remaining substances substantially do not react with the one or more poly(meth)acrylates given light curing under appropriately selected conditions, in particular at room temperature (23° C.). For this reason, in one preferred embodiment, no acrylic acid or other monomers having one or more carboxyl groups are included as comonomer (ii) in the monomer composition of the poly(meth)acrylate. In one specific embodiment, the one or more poly(meth)acrylates additionally are also inert after the activation of the curing reaction. This means that in this specific preferred embodiment, no monomers capable of cationic copolymerization with epoxides are used as comonomers (ii) either. Accordingly, the known monomers 3,4-epoxycyclohexylmethyl methacrylate, glycidyl methacrylate, 2-isocyanatoethyl acrylate, 2-isocyanatoethyl methacrylate, isopropenyldimethylbenzyl isocyanate, itaconic anhydride, 4-hydroxybutyl acrylate glycidyl ether, and (2-oxo-1,3-dioxolan-4-yl)methyl acrylate, or similar reactive monomers, are not used as comonomers (ii) in the monomer composition of the poly(meth)acrylate, and so the one or more poly(meth)acrylates contain no hydroxyl groups, oxirane groups, such as epoxide or oxetane, for example, and no cyclic ether groups either.

The reactive adhesive compound of the reactive pressure-sensitive adhesive tape of the disclosure is cured via cationic polymerization or via a cationic reaction mechanism, and so in one preferred embodiment the comonomers (ii) of the poly(meth)acrylate contain no aminic groups, such as, for example, 2-(dimethylamino)ethyl acrylate, acrylamide, methacrylamide, 4-acrylomorpholine, N,N-dimethylacrylamide, N-methylolmethacrylamide, N-vinylcaprolactam, and N-vinylpyrrolidone.

The basis compound of the reactive adhesive compound of the reactive pressure-sensitive adhesive tape of the disclosure comprises 20% to 65% by weight of at least one epoxide compound (b), and more particularly the basis compound comprises 30% to 60% and more preferably 35% to 55% by weight of at least one epoxide compound (b), based in each case on the total weight of the constituents of the basis compound of the reactive adhesive compound.

The stated weight percentage figures are based on the one epoxide compound or on the total of all epoxide compounds, if two or more epoxide compounds are present.

In the reactive adhesive compound of the reactive pressure-sensitive adhesive tape of the disclosure, the weight ratio of the entirety of the poly(meth)acrylates to the entirety of the epoxide compounds is preferably 3:1 to 1:3, more preferably 2:1 to 1:2, more particularly 1.5:1 to 1:1.5.

The basis compound of the reactive adhesive compound of the reactive pressure-sensitive adhesive tape of the disclosure comprises at least one epoxide compound (b). In line with the understanding of the skilled person, epoxide compounds are compounds which carry at least one oxirane group. They may be aromatic or aliphatic, more particularly cycloaliphatic, in nature. Epoxide compounds may comprise not only monomeric but also oligomeric or polymeric epoxide compounds. Epoxide compounds frequently have on average at least two epoxide groups per molecule, preferably more than two epoxide groups per molecule. The “average” number of epoxide groups per molecule is defined as the number of epoxide groups in the epoxide-containing material, divided by the total number of epoxide molecules present.

The oligomeric or polymeric epoxide compounds usually comprise linear polymers having terminal epoxide groups (e.g., a diglycidyl ether of a polyoxyalkylene glycol), polymers having scaffold oxirane units (e.g., polybutadiene polyepoxide) and polymers having epoxide side groups (e.g., a glycidyl methacrylate polymer or copolymer). Reaction of epoxy resins with carboxyl-terminated butadiene acrylonitrile (CTBN) produces what are called epoxy-terminated nitrile rubbers (ETBN). ETBN of this kind are available commercially for example from Huntsman International under the name HYPRO® ETBN—examples are Hypro® 1300X40 ETBN, Hypro® 1300X63 ETBN and Hypro® 1300X68 ETBN.

The molecular weight of the at least one epoxide compound or epoxide compounds included in the light-curing adhesive compound of the disclosure may vary from 58 to about 100,000 g/mol, with the molecular weight being an important parameter for adjusting the dynamic viscosity. Illustrative epoxide compounds encompass epoxycyclohexanecarboxylates, examples being 3,4-epoxycyclohexylmethyl 3′,4′-epoxycyclohexanecarboxylate, 3,4-epoxy-2-methylcyclohexylmethyl 3,4-epoxy-2-methylcyclohexanecarboxylate, and bis(3,4-epoxy-6-methylcyclohexylmethyl) adipate. Further examples of epoxide compounds are disclosed for example in U.S. Pat. No. 3,117,099 Å, which is incorporated herein by reference. Further suitable epoxide compounds particularly useful in the application of this disclosure encompass glycidyl ether monomers, as are disclosed for example in U.S. Pat. No. 3,018,262 Å, which is incorporated herein by reference. Examples are the glycidyl ethers of polyhydric phenols, which are obtained by reaction of a polyhydric phenol with an excess of chlorohydrin, such as epichlorohydrin (e.g., the diglycidyl ether of 2,2-bis(2,3-epoxypropoxyphenol)propane). More particularly, diglycidyl ethers of bisphenols, examples being bisphenol A (4,4′-(propane-2,2-diyl)diphenol) and bisphenol F (bis(4-hydroxyphenyl)methane), and hydrogenated variants of these. Reaction products of these kinds are available commercially in different molecular weights and physical states (examples being what are called type 1 to type 10 BADGE (Bisphenol A DiGlycidyl Ether) resins). Typical examples of liquid bisphenol A diglycidyl ethers are Epikote™ 828, D.E.R.™ 331 and Epon™ 828, and an example of liquid hydrogenated bisphenol A diglycidyl ethers is Eponex™ 1510. Typical solid BADGE resins are Araldite® GT6071, GT7072, Epon™ 1001 and D.E.R.™ 662. Further reaction products of phenols with epichlorohydrin are the phenol and cresol novolac resins such as the Epiclon® products or Araldite® EPN and ECN products (e.g., ECN1273). Further suitable epoxide compounds are epoxy resins obtained from renewable raw materials, such as from oils, as for example epoxidized linseed oil, epoxidized soybean oil, or from the shells of the cashew nut, as for example epoxidized cardanols, or epoxy resins containing glycerol, such as, for example, bisphenol A reacted with epichlorohydrin which has been obtained from glycerol.

The conversion of the epoxide compounds during the curing reaction of the reactive adhesive compound takes place in particular through cationic polymerization via the epoxide groups. With epoxide compounds, adhesives of particularly high shear strength can be produced. Moreover, the crosslinking reactions have good initiation and handling qualities. In the uncured state, the reactive adhesive compounds produced using epoxide compounds are sufficiently storage-stable.

Preference is given correspondingly to a reactive pressure-sensitive adhesive tape of the disclosure wherein the at least one epoxide compound in the reactive adhesive compound is selected from the group consisting of cycloaliphatic epoxy resins, such as 3,4-epoxycyclohexylmethyl 3′,4′-epoxycyclohexanecarboxylate, bisphenol A diglycidyl ether (BADGE) resins, hydrogenated bisphenol A diglycidyl ether (BADGE) resins, epoxy-terminated nitrile rubbers (ETBN), and epoxy-terminated butadiene rubbers (EBN); particularly preferred are bisphenol A diglycidyl ethers and hydrogenated bisphenol A diglycidyl ethers.

It has been surprisingly determined that hydrogenated diglycidyl ethers of bisphenols, such as bisphenol A diglycidyl ether, are particularly suitable since they show a positive effect on the chemical resistance for bonds on aluminum. In one preferred embodiment, therefore, the reactive adhesive compound comprises 10% to 70% by weight of one or more hydrogenated diglycidyl ethers of bisphenols, such as bisphenol A diglycidyl ether, preferably 15% to 40% by weight of one or more hydrogenated diglycidyl ethers of bisphenols. In particular, mixtures of bisphenol A diglycidyl ethers with hydrogenated bisphenol A diglycidyl ethers show well-rounded chemical resistances on the test substrates PC and Al.

Additionally preferred is a reactive pressure-sensitive adhesive tape of the disclosure wherein the reactive adhesive compound comprises two or more epoxide compounds, more particularly epoxy resins, with at least one of the epoxide compounds being a solid, more particularly a solid having a softening temperature of at least 45° C., or a substance of high viscosity, preferably having a dynamic viscosity at 25° C. of 50 Pa-s or more, particularly preferably 100 Pa·s or more, especially preferably 150 Pa·s or more (measured according to Deutsches Institut fir Normung (DIN) 53019-1 from 2008; 25° C., shear rate 1 s⁻¹).

Particularly preferred is a reactive pressure-sensitive adhesive tape of the disclosure wherein the reactive adhesive compound comprises two or more epoxide compounds, more particularly epoxy resins, with at least one epoxide compound (b1) being a liquid at 25° C. with a dynamic viscosity of 40 Pa·s or less, preferably 20 Pa·s or less, and at least one epoxide compound (b2) being a solid or a substance of high viscosity at 25° C., with a dynamic viscosity of 50 Pa·s or more. Reactive adhesive compounds with liquid and solid epoxide compounds or epoxide compounds of high viscosity display particularly well-rounded adhesive properties in the uncured state.

In one preferred embodiment, in the reactive adhesive compound, the weight ratio of the entirety of the liquid epoxide compounds (b1) whose dynamic viscosity at 25° C. is 40 Pa·s or less to the entirety of the solid epoxide compounds (b2) (solid having a softening temperature of at least 45° C. or a substance of high viscosity with a dynamic viscosity at 25° C. of 50 Pa·s or more) is 1:2 to 5:1 and more preferably 1.5:1 to 3:1.

In one preferred embodiment, the at least one reactive adhesive compound of the reactive pressure-sensitive adhesive tape of the disclosure comprises
as a basis compound
35% to 80% by weight of at least one poly(meth)acrylate (a);
5% to 45% by weight of at least one liquid epoxide compound (b1), more particularly 20% to 40% by weight;
5% to 30% by weight of at least one solid epoxide compound (b2), more particularly 15% to 25% by weight;
where the total amount of all poly(meth)acrylates and epoxide compounds present makes
100% by weight; and
moreover
0.1% to 5% by weight, based on 100% by weight of the basis compound, of at least one initiator (c) for curing the one or more epoxide compounds.

Surprisingly it has been determined that reactive PSAs containing 3,4-epoxycyclohexylmethyl 3′,4′-epoxycyclohexanecarboxylate, which is used very frequently in light-curing epoxy adhesives, exhibit lower chemical resistance in the majority of cases. For this reason, the liquid epoxide compound in the reactive adhesive compound of the reactive pressure-sensitive adhesive tape of the disclosure comprises preferably bisphenol A diglycidyl ethers or hydrogenated bisphenol A diglycidyl ethers or mixtures thereof.

In one preferred embodiment, in the reactive adhesive compound, the weight ratio of the entirety of the liquid epoxide compounds (b1) whose dynamic viscosity at 25° C. is 40 Pa·s or less to the entirety of the solid epoxide compounds (b2) (solid having a softening temperature of at least 45° C. or a substance of high viscosity with a dynamic viscosity at 25° C. of 50 Pa·s or more) is 1:2 to 5:1 and more preferably 1.5:1 to 3:1, with the liquid epoxide compounds (b1) comprising at least one, or two or more, liquid hydrogenated bisphenol A diglycidyl ethers.

The reactive adhesive compound of the reactive pressure-sensitive adhesive tape of the disclosure comprises 0.1% to 5% by weight of at least one initiator (c) for curing the epoxide compound; more particularly, the reactive adhesive compound comprises 0.1% to 3% by weight and more preferably 0.1% to 2% by weight of at least one initiator (c), based in each case on 100% by weight of basis compound.

With the presently envisaged usage of at least one epoxide compound in the reactive adhesive compound, the polymerization takes place preferably by means of cationic polymerization and the reactive adhesive compound therefore comprises an initiator for the cationic polymerization. The one or the two or more initiators is or are preferably selected from the group consisting of radiation-activated initiators and thermally activated initiators.

Thermally activated initiators that can be used for the purposes of the present disclosure for cationic curing of epoxides are, in particular, pyridinium, ammonium (especially anilinium), and sulfonium (especially thiolanium) salts and also lanthanoid triflates. Very advantageous are N-benzylpyridinium salts and benzylpyridinium salts, where aromatics may be substituted for example by alkyl, alkoxy, halogen or cyano groups. J. Polym. Sci. A, 1995, 33, 505ff; US 2014/0367670 A1; U.S. Pat. No. 5,242,715 Å; J. Polym. Sci. B, 2001, 39, 2397ff; EP 393893 A1; Macromolecules, 1990, 23, 431ff; Macromolecules, 1991, 24, 2689; Macromol. Chem. Phys., 2001, 202, 2554ff; WO 2013/156509 A2; and JP 2014/062057 A1 identify corresponding compounds which can be used, all of which are incorporated herein by reference in their entireties. Among the commercially available initiator systems, representative examples of compounds which can be used very advantageously are San-Aid SI 80 L, San-Aid SI 100 L, San-Aid SI 110 L from Sanshin, Opton CP-66 and Opton CP-77 from Adeka, and K-Pure® TAG 2678, K-Pure® CXC 1612 and K-Pure® CXC 1614 from King Industries. Others which can be used very advantageously are lanthanoid triflates (samarium(III) triflate, ytterbium(III) triflate, erbium(III) triflate, dysprosium(III) triflate) available from Sigma Aldrich and Alfa Aesar (lanthanum(III) triflate). Suitable anions for the initiators that can be used include hexafluoroantimonate, hexafluorophosphate, hexafluoroarsenate, tetrafluoroborate, and tetra(pentafluorophenyl)borate.

With a view to the subsequent handling qualities, it is particularly advantageous in the estimation of the disclosure to use crosslinking systems that crosslink by radiation, since radiative activation offers great handling-associated advantages. In one preferred embodiment, therefore, the at least one initiator in the reactive adhesive compound of the reactive pressure-sensitive adhesive tape of the disclosure is a radiation-activated initiator, also called photoinitiator, for cationic polymerization, and the reactive adhesive compound of the pressure-sensitive adhesive tape of the disclosure comprises preferably 0.1% to 5%, more preferably 0.1% to 3% and most preferably 0.1% to 2% by weight of at least one photoinitiator (c) for curing the at least one epoxide compound, based in each case on 100% by weight of basis compound.

A photoinitiator is understood to be a compound which under the influence of high-energy radiation is able to initiate a chemical reaction. The photoinitiator is preferably a UV initiator. UV initiators are known in principle to the skilled person. Photoinitiators which can be used for cationic UV-induced curing of epoxide compounds are, in particular, sulfonium-, iodonium- and metallocene-based systems.

Anions which form the counterions for sulfonium-, iodonium- and metallocene-based photoinitiators are preferably selected from the group consisting of tetrafluoroborate, tetraphenylborate, hexafluorophosphate, perchlorate, tetrachloroferrate, hexafluoroarsenate, hexafluoroantimonate, pentafluorohydroxyantimonate, hexachloroantimonate, tetrakispentafluorophenylborate, tetrakis(pentafluoromethylphenyl)borate, bis(trifluoromethylsulfonyl)amides, and tris(trifluoromethylsulfonyl)methides. Additionally conceivable as anions, especially for iodonium-based initiators, are also chloride, bromide, or iodide, although initiators substantially free from chlorine and bromine are preferred.

For examples of sulfonium-based cations, reference may be made to the observations in U.S. Pat. No. 6,908,722 B1, which is incorporated herein by reference in its entirety. One capable example of such a system is exemplified by triphenylsulfonium hexafluoroantimonate. Further suitable initiators are disclosed for example in U.S. Pat. No. 3,729,313 Å, U.S. Pat. No. 3,741,769 Å, U.S. Pat. No. 4,250,053 Å, U.S. Pat. No. 4,394,403 Å, U.S. Pat. No. 4,231,951 Å, U.S. Pat. No. 4,256,828 Å, U.S. Pat. No. 4,058,401 Å, U.S. Pat. No. 4,138,255 A and US 2010/063221 A1, all of which are incorporated herein by reference in their entireties.

Specific examples of sulfonium salts which can be used are triphenylsulfonium hexafluoroarsenate, triphenylsulfonium hexafluoroborate, triphenylsulfonium tetrafluoroborate, triphenylsulfonium tetrakis(pentafluorobenzyl)borate, methyldiphenylsulfonium tetrafluoroborate, methyldiphenylsulfonium tetrakis(pentafluorobenzyl)borate, dimethylphenylsulfonium hexafluorophosphate, triphenylsulfonium hexafluorophosphate, triphenylsulfonium hexafluoroantimonate, diphenylnaphthylsulfonium hexafluoroarsenate, tritolylsulfonium hexafluorophosphate, anisyldiphenylsulfonium hexafluoroantimonate, 4-butoxyphenyldiphenylsulfonium tetrafluoroborate, 4-chlorophenyldiphenylsulfonium hexafluoroantimonate, tris(4-phenoxyphenyl)sulfonium hexafluorophosphate, di(4-ethoxyphenyl)methylsulfonium hexafluoroarsenate, 4-acetylphenyldiphenylsulfonium tetrafluoroborate, 4-acetylphenyldiphenylsulfonium tetrakis(pentafluorobenzyl)borate, tris(4-thiomethoxyphenyl)sulfoniumhexafluorophosphate, di(methoxysulfonylphenyl)methylsulfonium hexafluoroantimonate, di(methoxynaphthyl)methylsulfonium tetrafluoroborate, di(methoxynaphthyl)methylsulfonium tetrakis(pentafluorobenzyl)borate, di(carbomethoxyphenyl)methylsulfonium hexafluorophosphate, (4-octyloxyphenyl)diphenylsulfonium tetrakis(3,5-bistrifluoromethylphenyl)borate, tris[4-(4-acetylphenyl)thiophenyl]sulfonium tetrakis(pentafluorophenyl)borate, tris(dodecylphenyl)sulfonium tetrakis(3,5-bistrifluoromethylphenyl)borate, 4-acetamidophenyldiphenylsulfonium tetrafluoroborate, 4-acetamidophenyldiphenylsulfonium tetrakis(pentafluorobenzyl)borate, dimethylnaphthylsulfonium hexafluorophosphate, trifluoromethyldiphenylsulfonium tetrafluoroborate, trifluoromethyldiphenylsulfonium tetrakis(pentafluorobenzyl)borate, phenylmethylbenzylsulfonium hexafluorophosphate, 5-methylthianthrenium hexafluorophosphate, 10-phenyl-9,9-dimethylthioxanthenium hexafluorophosphate, 10-phenyl-9-oxothioxanthenium tetrafluoroborate, 10-phenyl-9-oxothioxanthenium tetrakis(pentafluorobenzyl)borate, 5-methyl-10-oxothianthrenium tetrafluoroborate, 5-methyl-10-oxothianthrenium tetrakis(pentafluorobenzyl)borate, and 5-methyl-10,10-dioxothianthrenium hexafluorophosphate.

Specific examples of iodonium salts which can be used are diphenyliodonium tetrafluoroborate, di(4-methylphenyl)iodonium tetrafluoroborate, phenyl-4-methylphenyliodonium tetrafluoroborate, di(4-chlorophenyl)iodonium hexafluorophosphate, dinaphthyliodonium tetrafluoroborate, di(4-trifluoromethylphenyl)iodonium tetrafluoroborate, diphenyliodonium hexafluorophosphate, di(4-methylphenyl)iodonium hexafluorophosphate, diphenyliodonium hexafluoroarsenate, di(4-phenoxyphenyl)iodonium tetrafluoroborate, phenyl-2-thienyliodonium hexafluorophosphate, 3,5-dimethylpyrazolyl-4-phenyliodonium hexafluorophosphate, diphenyliodonium hexafluoroantimonate, 2,2′-diphenyliodonium tetrafluoroborate, di(2,4-dichlorophenyl)iodonium hexafluorophosphate, di(4-bromophenyl)iodonium hexafluorophosphate, di(4-methoxyphenyl)iodonium hexafluorophosphate, di(3-carboxyphenyl)iodonium hexafluorophosphate, di(3-methoxycarbonylphenyl)iodonium hexafluorophosphate, di(3-methoxysulfonylphenyl)iodonium hexafluorophosphate, di(4-acetamidophenyl)iodonium hexafluorophosphate, di(2-benzothienyl)iodonium hexafluorophosphate, diaryliodonium tristrifluoromethylsulfonylmethide, diphenyliodonium hexafluoroantimonate, diaryliodonium tetrakis(pentafluorophenyl)borate such as diphenyliodonium tetrakis(pentafluorophenyl)borate, [4-(2-hydroxy-n-tetradesiloxy)phenyl]phenyliodonium hexafluoroantimonate, [4-(2-hydroxy-n-tetradesiloxy)phenyl]phenyliodonium trifluorosulfonate, [4-(2-hydroxy-n-tetradesiloxy)phenyl]phenyliodonium hexafluorophosphate, [4-(2-hydroxy-n-tetradesiloxy)-phenyl]phenyliodonium tetrakis(pentafluorophenyl)borate, bis(4-tert-butylphenyl)iodonium hexafluoroantimonate, bis(4-tert-butylphenyl)iodonium hexafluorophosphate, bis(4-tert-butylphenyl)iodonium trifluorosulfonate, bis(4-tert-butylphenyl)iodonium tetrafluoroborate, bis(dodecylphenyl)iodonium hexafluoroantimonate, bis(dodecylphenyl)iodonium tetrafluoroborate, bis(dodecylphenyl)iodonium hexafluorophosphate, bis(dodecylphenyl)iodonium trifluoromethylsulfonate, di(dodecylphenyl)iodonium hexafluoroantimonate, di(dodecylphenyl)iodonium triflate, diphenyliodonium bisulfate, 4,4′-dichlorodiphenyliodonium bisulfate, 4,4′-dibromodiphenyliodonium bisulfate, 3,3′-dinitrodiphenyliodonium bisulfate, 4,4′-dimethyldiphenyliodonium bisulfate, 4,4′-bissuccinimidodiphenyliodonium bisulfate, 3-nitrodiphenyliodonium bisulfate, 4,4′-dimethoxydiphenyliodonium bisulfate, bis(dodecylphenyl)iodonium tetrakis(pentafluorophenyl)borate, (4-octyloxyphenyl)phenyliodonium tetrakis(3,5-bis-trifluoromethylphenyl)borate, and (tolylcumyl)iodonium tetrakis(pentafluorophenyl)borate, and ferrocenium salts (see, for example, EP 0 542 716 B1, which is incorporated herein by reference in its entirety) such as f5-(2,4-cyclopentadien-1-yl)-[(1,2,3,4,5,6,9)(1-methylethyl)benzene]iron.

The reactive adhesive compound of the reactive pressure-sensitive adhesive tape of the disclosure preferably comprises tris(4-(4-acetylphenyl)thiophenyl)sulfonium tetrakis(pentafluorophenyl)borate as photoinitiator for curing the epoxide compound.

Photoinitiators are typically employed individually or else as a combination of two or more photoinitiators. With the use of photoinitiators, combinations with what are called sensitizers are very useful for adapting the activation wavelength of the photoinitiation system to the chosen emission spectrum; for this, reference is made to the literature known to the skilled person, such as, for example, “Industrial Photoinitiators: A technical guide” 2010 by A. W. Green, which is incorporated herein by reference in its entirety. In these cases, typically, the fraction of photoinitiators in the reactive adhesive compound is not more than 4% by weight but at least 0.1% by weight, and is situated preferably within the range from 0.5% to 2% by weight. The fraction of sensitizers is customarily not more than 3% by weight and is situated preferably within the range from 0.5% to 2% by weight, based in each case on 100% by weight of basis compound.

The reactive adhesive compound of the reactive pressure-sensitive adhesive tape of the disclosure may optionally contain further additives and/or auxiliaries which are known in the prior art. The fraction of the further additives and/or auxiliaries may be situated within the range from 0% to about 20% by weight, preferably 0% to about 15% by weight, more preferably 0% to about 10% by weight, and most preferably 0% to about 5% by weight, based in each case on 100% by weight of the basis compound.

Examples of further additives and/or auxiliaries are further polymers, reactive monomers, fillers, dyes, nucleating agents, further photoinitiators, rheological additives (for example, fumed silica), expandants, adhesion-boosting additives (adhesion promoters, especially silanes and tackifier resins), compounding agents, plasticizers and/or aging inhibitors, light stabilizers and UV stabilizers, in the form for example of primary and secondary antioxidants.

In particular, and according to preferred embodiments, the fraction of fillers, as for example glass beads or SiLibeads® 5211, is up to 50% by weight, more particularly up to 40% by weight, based on 100% by weight of the basis compound.

Especially preferred additives are silane adhesion promoters or open time additives. An example of a silane adhesion promoter is 3-trimethoxysilylpropyl methacrylate (CAS No.: 2530-85-0), obtainable under the trade name Dynasylan® MEMO (Evonik A G, Essen, Germany). Suitable open time additives are polyethylene glycol 400 (PEG 400) CAS: 25322-68-3 or polyethylene glycol 600 (PEG 600) CAS: 25322-68-3.

As open time additive, the reactive adhesive compound of the reactive pressure-sensitive adhesive tape of the disclosure preferably comprises at least one substance selected from the group consisting of polyethylene glycol (PEG), polypropylene glycol (PPG), tertiary amines, and crown ethers (as for example 18-crown-6); more particularly at least one substance selected from PEG having a weight-average molecular weight, determined as described hereinabove, of 400 to 10,000 g/mol, for example to 5,000 g/mol, very preferably to 1,000 g/mol, and more particularly PEG 600. The effect of these substances is that, after the curing of the reactive adhesive compounds has been initiated, there still remains a time—referred to as the open time—during which curing does not yet ensue, or at least not to a significant extent, and they may therefore be identified as “open time additives.” As has emerged, with the open time additives recited here it is possible to achieve open times, particularly for UV-curable reactive adhesive compounds, of at least a minute, frequently of 1 to 5 minutes, with the dark reaction being over at a temperature of 25° C. after 24 hours. A reaction is referred to as “over” for the purposes of this disclosure when the bond strength of the reactive pressure-sensitive adhesive tape after 24 h is at least 2 MPa.

The reactive adhesive compound may in principle comprise one or more open time additives. The aforementioned open time additives, if comprised, are present in the reactive adhesive compound preferably at 0.1% to 10% by weight, more preferably at 0.2% to 5% by weight, more particularly at 0.3% to 4% by weight, based in each case on 100% by weight of the basis compound.

The reactive pressure-sensitive adhesive tape of the disclosure comprises at least one reactive adhesive compound. In one preferred embodiment, the at least one reactive adhesive compound takes the form of an adhesive layer. In this case, the reactive pressure-sensitive adhesive tape of the disclosure concerns an adhesive tape or adhesive film without carrier layer, in other words a carrierless (foamed and unfoamed) reactive pressure-sensitive adhesive transfer tape. One preferred embodiment of the reactive pressure-sensitive adhesive tape is that wherein the pressure-sensitive adhesive tape comprises a carrier layer as well as the adhesive layer. This includes single-sided adhesive tapes and double-sided adhesive tapes comprising at least one outer layer consisting of the reactive adhesive compound of the disclosure, as defined in the claims.

For the skilled person within the field of adhesive bonding, the concept of adhesive tape is clear. In the context of the present disclosure, the expression “tape” refers to all thin, sheetlike structures, i.e., structures having a predominant extent in two dimensions, more particularly films, film portions and labels, preferably tapes with extended length and limited width, and corresponding tape portions.

The carrier layer usually refers to that layer of a multilayer adhesive tape of this kind that critically determines the mechanical and physical properties of the adhesive tape, such as the tear resistance, stretchability, insulation capacity or resilience, for example. Customary carrier materials are familiar to the skilled person and are, for example, woven fabrics, laid scrims and polymeric films, examples being PET films and polyolefin films. The carrier layer, however, may also itself be pressure-sensitively adhesive.

In the reactive pressure-sensitive adhesive tapes of the disclosure, the adhesive layers may be lined with what is called a release liner, for transport, storage or die cutting. This release liner permits easy unwinding, for example, and protects the PSA from soiling. Such release liners customarily consist of a single- or double-sidedly siliconized polymeric film (e.g., PET or PP) or of a siliconized paper carrier.

The thickness of the layer of the reactive adhesive compound in the reactive pressure-sensitive adhesive tape of the disclosure is preferably 5 μm to 400 m (measured using a standard commercial thickness gauge, e.g., the DM 2000 from Wolf Messtechnik GmbH). A layer thickness of 10 μm to 300 μm is more preferred, a layer thickness of 30 μm to 200 μm even more preferred, and a layer thickness of 50 μm to 110 μm the most preferred. Higher layer thicknesses, of up to 1000 μm, for example, are conceivable and realizable with the reactive adhesive compound of the present disclosure. This is the case in particular when components with relatively large gap dimensions are being installed. Preferred layer thicknesses here are up to 1,000 μm, more preferably up to 900 μm, and even more preferably up to 800 μm. In order to ensure the internal strength prior to curing, adhesive tapes of this kind are frequently provided with a carrier layer in the interior, and so two-sided activation may exceptionally be necessary.

Also disclosed, starting from the reactive pressure-sensitive adhesive tape of the disclosure, is the use of the reactive pressure-sensitive adhesive tape of the disclosure for bonding two or more components and/or substrates, preferably at room temperature, by curing of the reactive adhesive compound.

The method of the disclosure for bonding two substrates, preferably at room temperature, using the reactive pressure-sensitive adhesive tape of the disclosure comprises the following steps:
A) applying the reactive pressure-sensitive adhesive tape to a first substrate
B) activating the reactive pressure-sensitive adhesive tape by irradiation with UV light, preferably from a UV-LED lamp
C) joining a second substrate onto the activated reactive pressure-sensitive adhesive tape.

Irradiation is carried out in this method preferably with a wavelength of 365 nm or 385 nm, more preferably 365 nm. Corresponding UV-LED lamps are available in the specialist trade, an example being the LED Cube from Hönle (Dr. Hönle AG, Gilching, Germany). Additionally, the method of the disclosure may comprise the activation lasting less than 45 seconds, preferably less than 30 seconds, more preferably less than 15 seconds, more preferably still less than 10 seconds, more particularly less than 7 seconds. In this method, in particular, an activation/irradiation time of less than 15 seconds or 10 seconds has emerged as being outstandingly suitable and these times are particularly advantageous since they allow very short cycle times in the industrial operation.

A further subject of the disclosure is the use of the reactive pressure-sensitive adhesive tape of the disclosure as a bonding agent in the production of electronic, optical, or precision mechanical devices, more particularly portable electronic, optical, or precision mechanical devices.

Portable devices of these kinds are more particularly:
cameras, digital cameras, photographic accessories (such as exposure meters, flashguns, diaphragms, camera casings, lenses, etc.), film cameras, video cameras;
microcomputers (portable computers, pocket computers, pocket calculators), laptops, notebook PCs, netbook PCs, ultrabook PCs, tablet computers, handhelds, electronic diaries and organizers (so-called “electronic organizers” or “personal digital assistants”, PDAs, palmtops), modems;
computer accessories and operating units for electronic devices, such as mice, drawing pads, graphics tablets, microphones, speakers, games consoles, gamepads, remote controls, remote operating devices, touchpads;
monitors, displays, screens, touch-sensitive screens (sensor screens, touchscreen devices), projectors;
reading devices for electronic books (“e-books”);
mini-TVs, pocket TVs, devices for playing films, video players;
radios (including mini and pocket radios), Walkmans, Discmans, music players for, e.g., CD, DVD, Blu-ray, cassettes, USB, MP3; headphones;
cordless telephones, cell phones, smartphones, two-way radios, hands-free telephones, devices for summoning people (pagers, beepers);
mobile defibrillators, blood sugar meters, blood pressure monitors, step counters, pulse meters;
torches, laser pointers;
mobile detectors, optical magnifiers, binoculars, night vision devices, GPS devices, navigation devices, portable interface devices for satellite communication;
data storage devices (USB sticks, external hard drives, memory cards); and wristwatches, digital watches, pocket watches, chain watches, and stopwatches.

### Experimental Section

Raw materials used:

| | |
|---|---|
| 2-Phenoxyethyl acrylate (PEA) | CAS No. 48145-04-6, monomer of |
| | poly(meth)acrylate |
| | BASF |
| Benzyl acrylate (BzA) | CAS No. 2495-35-4, monomer of |
| | poly(meth)acrylate |
| | KOWA Europe GmbH |
| Benzyl methacrylate (BzMA) | CAS No. 2495-37-6, monomer of |
| | poly(meth)acrylate |
| | Evonik Industries AG |
| 2-Phenoxyethyl methacrylate | CAS No. 10595-06-9, monomer of |
| (PEMA) | poly(meth)acrylate |
| | Sigma-Aldrich |
| Methyl methacrylate (MMA) | CAS No. 80-62-6, monomer of poly(meth)acrylate |
| | Sigma-Aldrich |
| n-Butyl acrylate (BA) | CAS No. 141-32-2, monomer of poly(meth)acrylate |
| | BASF |
| Methyl acrylate (MA) | CAS No. 96-33-3, monomer of poly(meth)acrylate |
| | BASF |
| 2,2′-Azobis(2-methylbutyronitrile) | CAS No. 13472-08-7, polymerization initiator |
| | Akzo Nobel |
| Di(4-tert-butylcyclohexyl) peroxy- | CAS No. 15520-11-3, polymerization initiator |
| dicarbonate | Akzo Nobel |
| Kurarity ™ LA3320 | Acrylate triblock copolymer from Kuraray |
| | consisting of butyl acrylate in the middle block and |
| | methyl methacrylate in the hard block. |
| D.E.R. ™ 331 | Liquid bisphenol A diglycidyl ether from Olin with |
| | an epoxy equivalent weight (EEW) of 182-192 g/eq |
| | and a viscosity of ~12 Pa · s measured at 23° C. |
| D.E.R. ™ 662 | Solid bisphenol A diglycidyl ether from Olin with |
| | an EEW of 590-630 g/eq and a glass transition |
| | temperature of ~46° C. measured by DSC |
| Eponex ™ 1510 | Liquid hydrogenated bisphenol A diglycidyl ether |
| | from Hexion with an EEW of 205-215 g/eq and a |
| | viscosity of ~18-25 Pa s measured at 23° C. |
| Irgacure ® PAG 290 | Tris(4-(4-acetylphenyl)thiophenyl)sulfonium |
| | tetrakis(pentafluorophenyl)borate, from BASF |
| PEG 600 | Aldrich, CAS No. 25322-68-3, open time additive, |
| | Sigma-Aldrich |

### B. Preparation of the Poly(Meth)Acrylates

TABLE 1
Composition of the poly(meth)acrylates
(P) and comparative polymers (VP)

| | Monomer | Total fraction of | Molecular weight |
|---|---|---|---|
| Name | composition | monomers (i) | Mw [g/mol] |
| P1 | 100% by wt. PEA | 100% | 1,500,000 |
| P2 | 100% by wt. BzA | 100% | 1,500,000 |
| P3 | 80% by wt. PEA | 100% | 1,650,000 |
| | 20% by wt. BzMA | | |
| P4 | 77% by wt. PEA | 100% | 1,150,000 |
| | 23% by wt. PEMA | | |
| P5 | 69% by wt. PEA | 69% | 1,000,000 |
| | 31% by wt. MMA | | |
| VP1 | 29% by wt. PEA | 29% | 700,000 |
| | 51% by wt. BA | | |
| | 20% by wt. MA | | |
| VP2 | Kurarity ™ LA3320 | 0% | ~100,000 |

### Polymers P1 to P5 and VP1 were Prepared as Follows

A 4 L reactor conventional for radical polymerizations was charged with 320 g of the monomer mixture specified in Table 1 and with 273 g of ethyl acetate/isopropanol (96/04). After nitrogen gas had been passed through the reactor for 45 minutes with stirring, the reactor was heated up to 58° C. and 0.2 g of 2,2′-azobis(2-methylbutryronitrile) was added. A further 480 g of the monomer mixture specified in table 1 and 377 g of ethyl acetate were added continuously over 2 hours. The external heating bath was then heated to 65° C. and the reaction was carried out constantly at this external temperature. After reaction times of 1 h and 1.5 h, 0.3 g and 0.3 g again of 2,2′-azobis(2-methylbutryonitrile) were added. After 6 h and again after 7.5 h, portions of 0.12 g of di(4-tert-5-butylcyclohexyl) peroxydicarbonate were added for the purpose of reducing the residual monomers. Dilution with 160 g of ethyl acetate was carried out once after 2 h and 4 h. After a reaction time of 24 h, the reaction was discontinued and cooling took place to room temperature.

### C. Production of the Reactive Adhesive Compound

The reactive adhesive compounds were produced in the laboratory in accordance with the quantities in table 2 below. The epoxide compounds and, subsequently, the photoinitiator were added via stirring to the polymer which was present in solvent.

TABLE 2
Composition of the reactive adhesive compounds of
the disclosure (all figures in parts by weight):

| Components | K1 | K2 | K3 | K4 | K5 | K6 | K7 | K8 | K9 | K10 |
|---|---|---|---|---|---|---|---|---|---|---|
| Basis compound | | | | | | | | | | |
| P1 | 45 | | | | | | | | | |
| P2 | | 35 | 45 | | | | 45 | | | |
| P3 | | | | 35 | 45 | | | | | |
| P4 | | | | | | | | 55 | 65 | |
| P5 | | | | | | 45 | | | | 25 |
| D.E.R. ™ 331 | 17 | 20 | 17 | 20 | 17 | 17 | 38 | 14 | 11 | 11 |
| D.E.R. ™ 662 | 17 | 20 | 17 | 20 | 17 | 17 | 17 | 14 | 11 | 34 |
| Eponex ™ 1510 | 21 | 25 | 21 | 25 | 21 | 21 | | 17 | 13 | 30 |
| Further constituents | | | | | | | | | | |
| Irgacure ® PAG290 | 0.5 | 0.5 | 0.5 | 0.5 | 0.5 | 0.5 | 0.5 | 0.5 | 0.5 | 0.5 |
| PEG 600 | 1 | 1 | 1 | 1 | 1 | 1 | 1 | 1 | 1 | 1 |

TABLE 3
Composition of the comparative reactive adhesive
compounds (all figures in parts by weight):

| Components | V1 | V2 | V3 | V4 |
|---|---|---|---|---|
| P1 | | | 20 | |
| VP1 | 45 | | | 65 |
| VP2 | | 45 | | |
| D.E.R. ™ 331 | | 17 | 30 | 5 |
| D.E.R. ™ 662 | 34 | 17 | 29 | 10 |
| Eponex ™ 1510 | 21 | 25 | 21 | |
| Uvacure ® 1500 | | | | 20 |
| Irgacure ® PAG290 | 0.5 | 0.5 | 0.5 | 0.5 |
| PEG 600 | 1 | 1 | 1 | 1 |

### D. Production of the Reactive Pressure-Sensitive Adhesive Tapes

To produce the reactive layers of adhesive compound, i.e., the carrierless pressure-sensitive adhesive tapes, the various reactive adhesive compounds were applied from a solution to a conventional liner (siliconized polyester film), using a laboratory coating device, and were dried. The size of the layer of adhesive compound was approximately 21 cm×30 cm and the thickness of the layer of adhesive compound after drying is 100±5 m. Drying took place in each case first at room temperature (RT) for 15 minutes and for 15 minutes at 120° C. in a laboratory drying cabinet. The dried layers of adhesive compound after drying were each immediately laminated on the open side to a second liner (siliconized polyester film with relatively low release force).

### E. Test Methods and Test Results

Push-out (PC-PC)—initial:

The push-out test provides information on the bond strength of an adhesive product in the direction normal to the adhesive layer. Provided are a circular first substrate (1) (polycarbonate (PC), Macrolon 099, thickness 3 mm), having a diameter of 21 mm, a square second substrate (2) (polycarbonate, Macrolon 099, thickness 3 mm) of 40 mm side length—having a circular, centrally positioned opening (drilled hole) 9 mm in diameter, and the adhesive film sample under test, die cut in ring shape with an outer diameter of 18 mm and an inner diameter of 13 mm, to produce a ring having a disk width of 5 mm.

The three components stated above are used to produce a test specimen, the adhesive product being bonded centrally by its free surface to the substrate (1). Then the temporary protective film (siliconized PET liner) is removed and the adhesive is activated with at least 4,500 mJ/cm² using a 365 nm UV-LED (Hönle AG). This assembly is then applied to the substrate (2) by the now exposed side of the adhesive product within 2 minutes concentrically, namely such that the circular cutout in the substrate (2) is arranged precisely centrally over the circular first substrate 1 (the bond area is therefore 151 mm²), and the resulting assembly is pressed at a pressure of at least 10 bar for at least 10 seconds, producing the test specimen.

After having been pressed, the test specimens are conditioned for 72 hours at 23° C./50% relative humidity (rh). Following storage, the bonded assembly is clamped into a sample mount, so that the assembly is aligned horizontally. The test specimen is inserted into the sample mount with the polycarbonate disk (substrate (1)) downward and the bond strength is measured in a Zwick [Z020]. This measurement involves passing a steel die having a diameter of 7 mm through the circular opening in substrate (2) and determining the force required to part the circular substrate (1) from the square substrate (2). As the output value, the force determined is divided by the bond area and the force is reported in MPa.

Three samples per product are tested and the average value is reported as the index of the bond strength.

Push-out (PC-PC)—after 72 h at 65° C. in isopropanol/water:

To determine the chemical resistance of the bond, push-out test specimens constructed as described earlier on above were placed for 72 h into a 65° C. bath of isopropanol/water (70/30, i.e., 70% volume fractions to 30% volume fractions). On removal, the test specimens were reacclimatized at 23° C. and 50% rh for an hour. The bond strength was measured subsequently as described under Push-out—initial.

To determine the bond strength on aluminum, substrates selected were (1) a circular aluminum disk 1 mm thick (diameter 21 mm) and (2) a 2 mm thick square aluminum substrate of 40 mm side length having a circular, centrally positioned opening (drilled hole) 9 mm in diameter. The aluminum substrates are anodized E6 EV1 (alloy 5005 Å[AlMg1]).

To determine the bond strength on stainless steel (SUS), substrates selected were (1) a circular steel disk 3 mm thick (diameter 21 mm) and (2) a 2 mm thick square steel substrate of 40 mm side length having a circular, centrally positioned opening (drilled hole) 9 mm in diameter. The steel substrates are composed of VA-1.4301 steel (mirror-polished on one side).

Peel adhesion (on steel):

The peel adhesion here is determined on steel in analogy to ISO 29862:2007 (Method 3) at 23° C. and 50% relative humidity at a peeling speed of 300 mm/min and a peel angle of 180°. The reinforcing film used is an etched PET film with a thickness of 36 μm, as available from Coveme (Italy). A measurement strip 2 cm wide is bonded using a roller machine with 4 kg at a temperature of 23° C. The adhesive tape is peeled off immediately after application. The measurement value (in N/cm) is the average value from three individual measurements.

TABLE 4
Results for push-out and peel adhesion

| Test | K1 | K2 | K3 | K4 | K5 | K6 | K7 |
|---|---|---|---|---|---|---|---|
| Push-out (PC-PC) - initial [MPa] | 3.1 | 3.3 | 4.1 | 3.1 | 2.7 | 2.8 | 4.2 |
| Push-out (PC-PC) - after 72 h at | 1.6 | 0.7 | 1.0 | 1.7 | 2.3 | 1.2 | 1.9 |
| 65° C. in isopropanol/water [MPa] | | | | | | | |
| Peel adhesion on steel | AF, >1 N/cm | AF, >1 N/cm | AF, >1 N/cm | AF, >1 N/cm | AF, >1 N/cm | AF, >1 N/cm | AF, >1 N/cm |
| Test | K8 | K9 | K10 | V1 | V2 | V3 | V4 |
| Push-out (PC-PC) - initial [MPa] | 3.7 | 3.6 | 1.25 | 2.7 | 4.6 | n.d.1 | 2.9 |
| Push-out (PC-PC) - after 72 h at | 0.2 | 0.1 | 0.11 | n.d.2 | n.d.2 | n.d.1 | n.d.2 |
| 65° C. in isopropanol/water [MPa] | | | | | | | |
| Peel adhesion (on steel) | AF, >1 N/cm | AF, >1 N/cm | AF, >1 N/cm | AF, >1 N/cm | AF, >1 N/cm | CF, not PSA | AF, >1 N/cm |

Key to abbreviations:
AF = adhesive failure; CF = cohesive failure.
n.d.1 = not determinable. Adhesive was very soft and so coupons could not be bonded for the push-out test.
n.d.2 = The bond parted either after only 48 hours storage time in isopropanol/water or during preparation of the samples for the push-out tests. It is therefore not possible to perform the push-out test after 72 hours of storage in isopropanol/water.

All of the inventive adhesive compounds K1 to K11 exhibit outstanding initial bond strengths (push-out). Even after immersion in a mixture of isopropanol and water for 72 hours, the bond strengths are still sufficiently high or excellent, and so the inventive adhesive compounds K1 to K11 exhibit good to very good chemical resistance. The comparative adhesive compound V3 lacked pressure-sensitive adhesiveness and it was not possible to determine an initial bond strength. The comparative adhesive compounds V1, V2 and V4 did show acceptable initial bond strengths in the push-out test, but did not exhibit chemical resistance, as the bonds failed as early as during the immersion time in the mixture of isopropanol and water or, at the latest, during the preparation of samples for the push-out test, after removal from the mixture.

Surprisingly, when comparing K3 to K7, as set out in Table 5, it emerged that for the bond on Al—Al substrates and also on SUS-SUS, it may be an advantage to switch parts of the liquid epoxide compound for hydrogenated epoxide compounds. For instance, while K7 does exhibit a slightly better chemical resistance on PC as a substrate, it nevertheless, on A1 as a substrate, displays values which are lower (2.5 MPa, initial) by comparison with 3.1 MPa in the case of K3. The positive influence of the hydrogenated epoxide compound on the chemical resistance is manifested in particular after storage in isopropanol/water. Accordingly, the values on Al—Al (0.3 MPa) and SUS-SUS (0.6 MPa) for K3 are significantly higher than the 0.1 MPa on A1 and SUS of K7.

TABLE 5
Results of Push-out (in [MPa]) of
K3 and K8 for PC-PC, A1-A1 and SUS-SUS

| Test | K3 | K7 |
|---|---|---|
| Push-out (PC-PC) - initial | 4.1 | 4.2 |
| Push-out (PC-PC) - | 1.0 | 1.9 |
| after 72 h at 65° C. in isopropanol/water | | |
| Push-out (A1-A1) - initial | 3.1 | 2.5 |
| Push-out (A1-A1) - | 0.3 | 0.1 |
| after 72 h at 65° C. in isopropanol/water | | |
| Push-out (SUS-SUS) - initial | 9.3 | 10.1 |
| Push-out (SUS-SUS) - | 0.6 | 0.1 |
| after 72 h at 65° C. in isopropanol/water | | |

According to a first aspect of the present disclosure, a reactive pressure-sensitive adhesive tape comprising at least one reactive adhesive compound comprising a basis compound, where the basis compound comprises (a) 35% to 80% by weight of at least one poly(meth)acrylate, and (b) 20% to 65% by weight of at least one epoxide compound, the total amount of the at least one poly(meth)acrylate and the at least one epoxide compound in the basis compound making 100% by weight; and where the at least one reactive adhesive compound further comprises (c) 0.1% to 5% by weight, based on 100% by weight of the basis compound, of at least one initiator for curing the epoxide compound; wherein the at least one poly(meth)acrylate (a) derives from a monomer composition which comprises (i) 55% to 100% by weight of one or more monomers selected from the group consisting of (a) one or more monomers of the formula (I)

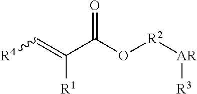

in which R¹ is a hydrogen atom or a methyl group, R² is an unsubstituted, linear or branched C₁-C₂₂ alkyl chain, AR is an aromatic radical, R³ is H, an unsubstituted, linear or branched C₁-C₅ alkyl chain, a hydroxyl group, a C₁-C₁₀ alkoxy group or an aryloxy group, R⁴ is H or a phenyl ring, (b) one or more monomers of the formula (II)

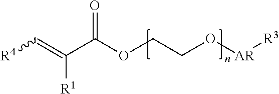

in which R¹ is a hydrogen atom or a methyl group, AR is an aromatic radical, R³ is H, an unsubstituted, linear or branched C₁-C₅ alkyl chain, a hydroxyl group, a C₁-C₁₀ alkoxy group or an aryloxy group, and R⁴ is H or a phenyl ring, and n is 0 to 10, (c) styrene, and (d) methylstyrene; and (ii) 0% to 45% by weight of one or more comonomers, where the one or more comonomers are selected from the group consisting of (meth)acrylate monomers and copolymerizable vinyl monomers, where there is no match between the one or more comonomers and the monomers of the formula (I), the monomers of the formula (II), styrene and methylstyrene, and where weight fractions are each based on a total weight of the monomer composition.

According to a second aspect of the present disclosure, the reactive pressure-sensitive adhesive tape of the first aspect is presented, wherein the monomer composition from which the at least one poly(meth)acrylate (a) derives comprises (i) 55% to 100% by weight of one or more monomers selected from the group consisting of (a) one or more monomers of the formula (Ia)

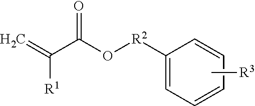

in which R¹ is a hydrogen atom or a methyl group, R² is an unsubstituted, linear or branched C₁-C₂₂ alkyl chain, and R³ is H, an unsubstituted, linear or branched C₁-C₅ alkyl chain, a hydroxyl group, a C₁-C₁₀ alkoxy group or an aryloxy group, and (b) one or more monomers of the formula (IIa)

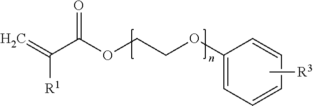

in which R¹ is a hydrogen atom or a methyl group, R³ is H, an unsubstituted, linear or branched C₁-C₅ alkyl chain, a hydroxyl group, a C₁-C₁₀ alkoxy group or an aryloxy group, and n is 0 to 10; and (ii) 0% to 45% by weight of one or more comonomers, where the one or more comonomers are selected from the group of the (meth)acrylate monomers, where there is no match between the one or more comonomers and the monomers of the formula (Ia), the monomers of the formula (IIa), styrene and methylstyrene, and where the weight fractions are each based on the total weight of the monomer composition.

According to a third aspect of the present disclosure, the reactive pressure-sensitive adhesive tape of the second aspect is presented, wherein a glass transition temperature (T_{g}) of a homopolymer of the one or more comonomers is greater than 0° C.

According to a fourth aspect of the present disclosure, the reactive pressure-sensitive adhesive tape of any one of the first through third aspects is presented, wherein the one or more monomers (i) are selected from the group consisting of benzyl acrylate, phenyl acrylate, benzyl methacrylate, phenyl methacrylate, 2-phenoxyethyl acrylate and 2-phenoxyethyl methacrylate.

According to a fifth aspect of the present disclosure, the reactive pressure-sensitive adhesive tape of any one of the first through fourth aspects is presented, wherein the basis compound in the at least one reactive adhesive compound comprises: (a) 40% to 70% by weight of the at least one poly(meth)acrylate, and (b) 30% to 60% by weight of the at least one epoxide compound, the total amount of the at least one poly(meth)acrylate and the at least one epoxide compound present making 100% by weight, and where the at least one reactive adhesive compound further comprises (c) 0.1% to 3% by weight of the at least one initiator for curing the epoxide compound, based on 100% by weight of the basis compound.

According to a sixth aspect of the present disclosure, the reactive pressure-sensitive adhesive tape of the fifth aspect is presented, wherein the basis compound in the at least one reactive adhesive compound comprises: (a) 45% to 65% by weight of the at least one poly(meth)acrylate, and (b) 35% to 55% by weight of the at least one epoxide compound, the total amount of the at least one poly(meth)acrylate and the at least one epoxide compound present making 100% by weight, and where the at least one reactive adhesive compound further comprises (c) 0.1% to 2% by weight of the at least one initiator for curing the epoxide compound, based on 100% by weight of the basis compound.

According to a seventh aspect of the present disclosure, the reactive pressure-sensitive adhesive tape of any one of the first through sixth aspects is presented, wherein the at least one initiator is at least one photoinitiator.

According to an eighth aspect of the present disclosure, the reactive pressure-sensitive adhesive tape of any one of the first through seventh aspects is presented, wherein the at least one epoxide compound of the basis compound of the at least one reactive adhesive compound comprises at least one liquid epoxide compound (b1) and at least one solid epoxide compound (b2).

According to a ninth aspect of the present disclosure, the reactive pressure-sensitive adhesive tape of the eighth aspect is presented, wherein a weight ratio of an entirety of the at least one liquid epoxide compound (b1) to an entirety of the at least one solid epoxide compound (b2) in the at least one reactive adhesive compound is 1:2 to 5:1.

According to a tenth aspect of the present disclosure, the reactive pressure-sensitive adhesive tape of the ninth aspect is presented, wherein the weight ratio is 1.5:1 to 3:1.

According to an eleventh aspect of the present disclosure, the reactive pressure-sensitive adhesive tape of any one of the first through tenth aspects is presented, wherein the at least one epoxide compound is selected from the group consisting of cycloaliphatic epoxy resins, bisphenol A diglycidyl ether (BADGE) resins, hydrogenated bisphenol A diglycidyl ether (BADGE) resins, epoxy-terminated nitrile rubbers (ETBN), and epoxy-terminated butadiene rubbers (EBN).

According to a twelfth aspect of the present disclosure, the reactive pressure-sensitive adhesive tape of the eleventh aspects is presented, wherein the at least one epoxide compound is selected from the group consisting of bisphenol A diglycidyl ether resins and hydrogenated bisphenol A diglycidyl ether resins.

According to a thirteenth aspect of the present disclosure, the reactive pressure-sensitive adhesive tape of any one of the first through twelfth aspects is presented, wherein the at least one reactive adhesive compound takes a form of an adhesive layer.

According to a fourteenth aspect of the present disclosure, the reactive pressure-sensitive adhesive tape of the thirteenth aspect further comprises a carrier layer for the adhesive layer.

According to a fifteenth aspect of the present disclosure, an adhesive composition comprises: (I) a basis compound comprising: (a) 45% to 65% by weight of a polymerized monomer composition, the monomer composition comprising at least 55% by weight of (meth)acrylate monomers selected from the group consisting of 2-phenoxyethyl acrylate, benzyl acrylate, benzyl methacrylate, and 2-phenoxyethyl methacrylate; and (b) 35% to 55% by weight of an epoxide component comprising at least one epoxide compound, wherein, a combined weight percentage of the polymerized monomer composition and the epoxide component is 100% by weight of the basis compound; and (II) 0.1% to 5% by weight, based on 100% by weight of the basis compound, of a photoinitiator for curing the epoxide component; wherein, (a) the adhesive composition comprises (i) an uncured state and (ii) after curing from the uncured state, a cured state, (b) in the uncured state, the adhesive composition is a pressure-sensitive adhesive, and (c) in the cured state, the adhesive composition is a (semi-)structural adhesive.

According to a sixteenth aspect of the present disclosure, the adhesive composition of the fifteenth aspect further comprises 0.3% to 4% by weight, based on 100% by weight of the basis compound, of at least one open time additive selected from the group consisting of polyethylene glycol 400 and polyethylene glycol 600.

According to a seventeenth aspect of the present disclosure, the adhesive composition of any one of the fifteenth through sixteenth aspects is presented, wherein the epoxide component comprises (i) a liquid at room temperature bisphenol A diglycidyl ether and (ii) a solid at room temperature bisphenol A diglycidyl ether.

According to an eighteenth aspect of the present disclosure, a method for bonding two substrates using (i) the reactive pressure-sensitive adhesive tape of any one of the first through fourteenth aspects or (ii) the adhesive composition of any one of the fifteenth through seventeenth aspects, in the form of a reactive-pressure sensitive adhesive tape comprising the adhesive composition, comprising steps of: (A) applying the reactive pressure-sensitive adhesive tape to a first substrate; (B) activating the reactive pressure-sensitive adhesive tape by irradiation with UV light; and (C) joining a second substrate onto the activated reactive pressure-sensitive adhesive tape.

According to a nineteenth aspect of the present disclosure, the method of the eighteenth aspect is presented, wherein the step B of activating lasts less than 45 seconds.

According to a twentieth aspect of the present disclosure, the method of any one of the eighteenth through nineteenth aspects is presented, wherein the first substrate and the second substrate are components of an electronic, optical, or precision mechanical device.

What is claimed is:

1. A reactive pressure-sensitive adhesive tape comprising at least one reactive adhesive compound comprising a basis compound, where the basis compound comprises
(a) 35% to 80% by weight of at least one poly(meth)acrylate, and
(b) 20% to 65% by weight of at least one epoxide compound,
the total amount of the at least one poly(meth)acrylate and the at least one epoxide compound in the basis compound making 100% by weight;
and where the at least one reactive adhesive compound further comprises
(c) 0.1% to 5% by weight, based on 100% by weight of the basis compound, of at least one initiator for curing the epoxide compound;
wherein
the at least one poly(meth)acrylate (a) derives from a monomer composition which comprises
(i) 55% to 100% by weight of one or more monomers selected from the group consisting of
a. one or more monomers of the formula (I) 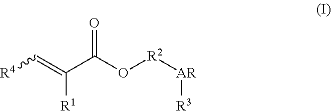
in which R¹ is a hydrogen atom or a methyl group,
R² is an unsubstituted, linear or branched C₁-C₂₂ alkyl chain,
AR is an aromatic radical,
R³ is H, an unsubstituted, linear or branched C₁-C₅ alkyl chain, a hydroxyl
group, a C₁-C₁₀ alkoxy group or an aryloxy group,
R⁴ is H or a phenyl ring,
b. one or more monomers of the formula (II) 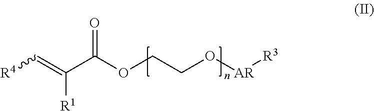
in which R¹ is a hydrogen atom or a methyl group,
AR is an aromatic radical,
R³ is H, an unsubstituted, linear or branched C₁-C₅ alkyl chain, a hydroxyl
group, a C₁-C₁₀ alkoxy group or an aryloxy group, and
R⁴ is H or a phenyl ring, and n is 0 to 10,
c. styrene, and
d. methylstyrene; and
(ii) 0% to 45% by weight of one or more comonomers,
where the one or more comonomers are selected from the group consisting of (meth)acrylate monomers and copolymerizable vinyl monomers,
where there is no match between the one or more comonomers and the monomers of the formula (I), the monomers of the formula (II), styrene and methylstyrene,
and
where weight fractions are each based on a total weight of the monomer composition.

2. The reactive pressure-sensitive adhesive tape of claim 1, wherein the monomer composition from which the at least one poly(meth)acrylate (a) derives comprises
(i) 55% to 100% by weight of one or more monomers selected from the group consisting of
a. one or more monomers of the formula (Ia) 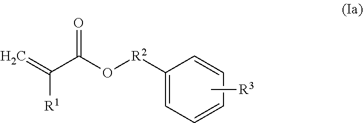
in which R¹ is a hydrogen atom or a methyl group,
R² is an unsubstituted, linear or branched C₁-C₂₂ alkyl chain, and
R³ is H, an unsubstituted, linear or branched C₁-C₅ alkyl chain, a hydroxyl
group, a C₁-C₁₀ alkoxy group or an aryloxy group, and
b. one or more monomers of the formula (IIa) 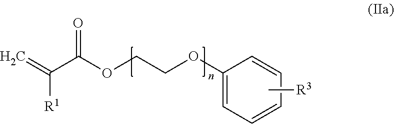
in which R¹ is a hydrogen atom or a methyl group,
R³ is H, an unsubstituted, linear or branched C₁-C₅ alkyl chain, a hydroxyl
group, a C₁-C₁₀ alkoxy group or an aryloxy group, and
n is 0 to 10; and
(ii) 0% to 45% by weight of one or more comonomers,
where the one or more comonomers are selected from the group of the (meth)acrylate monomers,
where there is no match between the one or more comonomers and the monomers of the formula (Ia), the monomers of the formula (IIa), styrene and methylstyrene,
and
where the weight fractions are each based on the total weight of the monomer composition.

3. The reactive pressure-sensitive adhesive tape of claim 2, wherein a glass transition temperature (T_{g}) of a homopolymer of the one or more comonomers is greater than 0° C.

4. The reactive pressure-sensitive adhesive tape of claim 1, wherein the one or more monomers (i) are selected from the group consisting of benzyl acrylate, phenyl acrylate, benzyl methacrylate, phenyl methacrylate, 2-phenoxyethyl acrylate and 2-phenoxyethyl methacrylate.

5. The reactive pressure-sensitive adhesive tape of claim 1, wherein the basis compound in the at least one reactive adhesive compound comprises:
(a) 40% to 70% by weight of the at least one poly(meth)acrylate, and
(b) 30% to 60% by weight of the at least one epoxide compound,
the total amount of the at least one poly(meth)acrylate and the at least one epoxide compound present making 100% by weight,
and where the at least one reactive adhesive compound further comprises
(c) 0.1% to 3% by weight of the at least one initiator for curing the epoxide compound,
based on 100% by weight of the basis compound.

6. The reactive pressure-sensitive adhesive tape of claim 5, wherein the basis compound in the at least one reactive adhesive compound comprises:
(a) 45% to 65% by weight of the at least one poly(meth)acrylate, and
(b) 35% to 55% by weight of the at least one epoxide compound,
the total amount of the at least one poly(meth)acrylate and the at least one epoxide compound present making 100% by weight,
and where the at least one reactive adhesive compound further comprises
(c) 0.1% to 2% by weight of the at least one initiator for curing the epoxide compound,
based on 100% by weight of the basis compound.

7. The reactive pressure-sensitive adhesive tape of claim 1, wherein the at least one initiator is at least one photoinitiator.

8. The reactive pressure-sensitive adhesive tape of claim 1, wherein the at least one epoxide compound of the basis compound of the reactive adhesive compound comprises at least one liquid epoxide compound (b1) and at least one solid epoxide compound (b2).

9. The reactive pressure-sensitive adhesive tape of claim 8, wherein a weight ratio of an entirety of the at least one liquid epoxide compound (b1) to an entirety of the at least one solid epoxide compound (b2) in the at least one reactive adhesive compound is 1:2 to 5:1.

10. The reactive pressure-sensitive adhesive tape of claim 9, wherein the weight ratio is 1.5:1 to 3:1.

11. The reactive pressure-sensitive adhesive tape of claim 1, wherein the at least one epoxide compound is selected from the group consisting of cycloaliphatic epoxy resins, bisphenol A diglycidyl ether (BADGE) resins, hydrogenated bisphenol A diglycidyl ether (BADGE) resins, epoxy-terminated nitrile rubbers (ETBN), and epoxy-terminated butadiene rubbers (EBN).

12. The reactive pressure-sensitive adhesive tape of claim 11, wherein the at least one epoxide compound is selected from the group consisting of bisphenol A diglycidyl ether resins and hydrogenated bisphenol A diglycidyl ether resins.

13. The reactive pressure-sensitive adhesive tape of claim 1, wherein the at least one reactive adhesive compound takes a form of an adhesive layer.

14. The reactive pressure-sensitive adhesive tape of claim 13 further comprises a carrier layer for the adhesive layer.

15. An adhesive composition comprising:
a basis compound comprising:
45% to 65% by weight of a polymerized monomer composition, the monomer composition comprising at least 55% by weight of (meth)acrylate monomers selected from the group consisting of 2-phenoxyethyl acrylate, benzyl acrylate, benzyl methacrylate, and 2-phenoxyethyl methacrylate; and
35% to 55% by weight of an epoxide component comprising at least one epoxide compound, wherein, a combined weight percentage of the polymerized monomer composition and the epoxide component is 100% by weight of the basis compound; and
0.1% to 5% by weight, based on 100% by weight of the basis compound, of a photoinitiator for curing the epoxide component;
wherein, the adhesive composition comprises (i) an uncured state and (ii) after curing from the uncured state, a cured state,
wherein, in the uncured state, the adhesive composition is a pressure-sensitive adhesive, and
wherein, in the cured state, the adhesive composition is a (semi-)structural adhesive.

16. The adhesive composition of claim 15 further comprising:
0.3% to 4% by weight, based on 100% by weight of the basis compound, of at least one open time additive selected from the group consisting of polyethylene glycol 400 and polyethylene glycol 600.

17. The adhesive composition of claim 15, wherein
the epoxide component comprises (i) a liquid at room temperature bisphenol A diglycidyl ether and (ii) a solid at room temperature bisphenol A diglycidyl ether.

18. A method for bonding two substrates using the reactive pressure-sensitive adhesive tape of claim 1 comprising steps of:
A) applying the reactive pressure-sensitive adhesive tape to a first substrate;
B) activating the reactive pressure-sensitive adhesive tape by irradiation with UV light; and
C) joining a second substrate onto the activated reactive pressure-sensitive adhesive tape.

19. The method of claim 18, wherein the step B of activating lasts less than 45 seconds.

20. The method of claim 18, wherein the first substrate and the second substrate are components of an electronic, optical, or precision mechanical device.
